(19) United States
(12) Patent Application Publication
(10) Pub. No.: US 2026/0350902 A1
(43) Pub. Date: Nov. 5, 2026

(54) GRAPHICS PROCESSING SYSTEMS

(71) Applicant: Arm Limited, Cambridge (GB)

(72) Inventors: Tobias Gutzmann, Lund (SE); Toomas Remmelg, Tanem (NO); Nico Reißmann, Trondheim (NO); Sven Gunnar Mikael Nilsson, Lund (SE)

(73) Assignee: Arm Limited, Cambridge (GB)

(21) Appl. No.: 19/194,141

(22) Filed: Apr. 30, 2025

(51) Int. Cl. G06T 15/00; G06F 9/30; G06F 9/38

(52) U.S. Cl. CPC G06T 15/005; G06F 9/30145; G06F 9/3836

(57) ABSTRACT

When providing a shader program for execution by a graphics processor, a control flow graph for the shader program is generated, and based on the control flow graph it is determined whether to move an instruction of a particular type to earlier in the program execution. When it is determined to move the instruction of the particular type to earlier in the program execution, the shader program is modified so as to move the instruction of the particular type earlier in the program execution.

### BACKGROUND

The technology described herein relates to graphics processing systems, and in particular to the operation of graphics processing systems that execute graphics processing pipelines that include one or more programmable processing stages (“shaders”).

Graphics processing is normally carried out by dividing the output to be generated, such as a frame to be displayed, into a number of similar basic components (so-called “primitives”) to allow the graphics processing operations to be more easily carried out. These “primitives” are usually in the form of simple polygons, such as triangles.

Once the primitives have been generated and defined, they can be processed in order to generate the desired render output, e.g. frame to be displayed.

This processing basically involves determining which sampling points in an array of sampling points covering the output area to be processed are covered by a primitive, and then determining the appearance each sampling point should have (e.g. in terms of its colour, etc.) to represent the primitive at that sampling point. These processes are commonly referred to as rasterising and rendering, respectively.

The rasterising process determines the sampling positions that should be used for a primitive (i.e. (the x, y) positions of the sample points to be used to represent the primitive in the output (e.g. frame to be displayed)).

The rendering process then derives the data, such as red, green and blue (RGB) colour values and “alpha” (transparency) value, necessary to represent the primitive at the sample points (i.e. “shades” each sample point). This can involve applying textures, blending sample point data values, etc.

These processes are typically carried out by testing sets of one, or of more than one, sampling point, and then generating for each set of sampling points found to include a sample point that is inside (covered by) the primitive in question (being tested), a discreet graphical entity usually referred to as a “fragment” on which the graphics processing operations (such as rendering) are carried out. Covered sampling points are thus, in effect, processed as fragments that will be used to render the primitives at the sampling points in question. The “fragments” are the graphical entities that pass through the rendering process (the rendering pipeline). Each fragment that is generated and processed may, e.g., represent a single sampling point or a set of plural sampling points, depending upon how the graphics processing system is configured.

Graphics processing is typically carried out in a pipelined fashion, with one or more pipeline stages operating on the data to generate the final render output, such as a frame to be displayed, graphics texture, etc.

Many graphics processing pipelines include one or more programmable processing stages, commonly referred to as “shaders”, which execute programs to perform graphics processing operations to generate the desired graphics data.

These shaders are programmable processing stages that execute shader programs on input data values to generate a desired set of output data (for further processing by the graphics processing pipeline and/or for output).

(A graphics processor (graphics processing unit (GPU)) will correspondingly comprise one or more programmable processing (“shader”) cores comprising appropriate programmable processing circuits (programmable execution units/engines) for executing graphics shader programs.)

One shader that a graphics processing pipeline may typically include is a fragment shader, that performs fragment shading operations on fragments generated by the rasteriser as part of the rendering process.

As well as the rasterisation and fragment shading operations, graphics processing normally also includes performing a number of other operations, such as hidden surface removal or other culling tests, such as alpha-to-coverage and/or alpha tests, stencil tests and/or depth tests, and blending.

Many graphics processing pipelines attempt to perform these tests before any fragment shading takes place, as if the test results in a fragment being discarded, the entire fragment shading operation for the discarded fragment can be omitted. However, there are certain circumstances where it is not possible to perform such tests “early” (before fragment shading takes place). Accordingly, it may be desirable to include in a fragment shading program instructions that perform (that trigger the performance of) one or more tests, such as a depth test and/or stencil test.

The Applicants have correspondingly recognised that in the case where an operation, such as a culling test, can be triggered as part of a fragment shader program execution, it would be desirable to perform such an operation earlier in the fragment shader program execution if possible, as, depending upon the outcome of the, e.g. culling test, that may allow further execution of the fragment shader program to be terminated.

The Applicants believe that there is scope for improvements to the operation of graphics processing systems that use graphics shader programs, such as fragment shader programs that can trigger culling tests as part of their execution.

### BRIEF DESCRIPTION OF THE DRAWINGS

A number of embodiments of the technology described herein will now be described by way of example only and with reference to the accompanying drawings, in which:

FIG. 1 shows an exemplary computer graphics processing system;

FIG. 2 shows an exemplary graphics processing pipeline;

FIG. 3 shows part of the operation of the graphics processing pipeline of FIG. 2;

FIG. 4 shows the overall operation of providing a shader program for execution in an embodiment;

FIG. 5 shows the process of modifying a shader program based on a control flow graph in an embodiment;

FIGS. 6 to 10 illustrate the modifying of a shader program in an embodiment; and

FIG. 11 shows the process of modifying a shader program based on a control flow graph in an embodiment.

Like reference numerals are used for like components where appropriate in the drawings.

### DETAILED DESCRIPTION

A first embodiment of the technology described herein comprises a method of providing a shader program for execution by a graphics processor that is operable to execute graphics shader programs, the method comprising:
generating a control flow graph for a shader program to be executed by a graphics processor;
based on the control flow graph:
   determining whether to move an instruction of a particular type to earlier in the program execution; and
   when it is determined to move the instruction of the particular type to earlier in the program execution, modifying the shader program so as to move the instruction of the particular type earlier in the program execution; and
providing the modified shader program for execution by a graphics processor.

A second embodiment of the technology described herein comprises an apparatus for providing a shader program for execution by a graphics processor that is operable to execute graphics shader programs, the apparatus comprising:
a processing circuit configured to generate a control flow graph for a shader program to be executed by a graphics processor;
a processing circuit configured to determine, based on the control flow graph:
   whether to move an instruction of a particular type to earlier in the program execution; and
   when it is determined to move the instruction of the particular type to earlier in the program execution, modify the shader program so as to move the instruction of the particular type earlier in the program execution; and
a processing circuit configured to provide the modified shader program for execution by a graphics processor.

The technology described herein relates to the provision of shader programs, such as fragment shader programs, for execution by graphics processors.

In the technology described herein a control flow graph is generated for a graphics shader program (which shader program may, e.g., and as discussed herein, be provided by an application that requires graphics processing). It is then determined from the control flow graph whether to move an instruction of a particular type (such as, as will be discussed further below, at least in the case of a fragment shader program, an instruction that triggers a fragment culling test), earlier in the shader program execution flow, and if so, the instruction is so-moved.

As will be discussed in more detail below, the Applicants have recognised that performing such control flow graph based restructuring of shader programs to be executed can facilitate the (potential) moving of particular instructions, such as “fragment culling test” instructions in a fragment shader program, to earlier in the shader program execution (which as discussed above may be desirable), and in a more efficient manner than may be provided/achieved by other shader program (compiler) optimisation tools and techniques.

The technology described herein can accordingly more efficiently and effectively facilitate the provision of shader programs, such as, and in an embodiment, fragment shader programs, having (potentially) more efficient program execution, for example, and in an embodiment, by facilitating the execution of instructions that could result in termination of execution of the shader program earlier in the shader program execution flow. This may then correspondingly allow such shader programs to be terminated earlier during execution (where it is possible to do that), thereby reducing the amount of shader program execution that a graphics processor may need to perform when generating a given render output, for example. This may then accordingly, for example, lead to increased performance and/or less energy consumption when executing the shader program in use.

The graphics shader program that is processed and provided in the manner of the technology described herein can be any suitable and desired shader program that it may be desired for a graphics processor (graphics processing pipeline) to execute.

Thus it may, for example, and in an embodiment, be one of: a vertex shader (a vertex shading program); a task shader (a task shading program); a tessellation shader (a tessellation shading program); a mesh shader (a mesh shading program); a tessellation evaluation shader (a tessellation evaluation shading program); a tessellation control shader (a tessellation control shading program); a geometry shader (a geometry shading program); a transform feedback shader (a transform feedback shading program); a hull shader (a hull shader program); a domain shader (a domain shading program); a fragment (pixel) shader (a fragment (pixel) shading program); and a compute shader (a compute shading program).

The technology described herein could be used for all shader programs that are to be executed by the graphics processing pipeline, or it may used for some but not all of the shader programs to be executed (for example, and in an embodiment, it may be used in respect of shader programs of a particular (selected) type or types, but not shader programs of other types).

In an embodiment, the graphics shader program that is processed and provided in the manner of the technology described herein is a fragment shading program (a fragment shader).

The control flow graph that is generated for a shader program can be any suitable and desired control flow graph, i.e. that determines and represents the “control flow” through the shader program (when executed).

The control flow graph that is generated for a shader program in the technology described herein should, and in an embodiment does, represent all the paths that might be traversed through the program during its execution. Thus, the control flow graph that is generated should, and in an embodiment does, comprise one or more (and in an embodiment a plurality) of nodes, each representing a “basic block” of the program (i.e. a straight-line sequence of code with a single entry point and a single exit point, where no branches or jumps occur within the block). Correspondingly, the control flow graph will and in an embodiment does comprises appropriate paths (edges) between the basic blocks (graph nodes), showing the possible flow paths (branches) between the identified basic blocks of the shader program.

The control flow graph for a shader program can be generated in any suitable and desired manner, such as, and in an embodiment, using known techniques for generating control flow graphs for programs.

In the technology described herein, once the control flow graph for a shader program has been generated, it is then determined based on the control flow graph whether to move an instruction of a particular type (of a selected, in an embodiment predetermined, type) to earlier in the execution of the shader program (and when it is so determined, to then modify the shader program so as to move the instruction to earlier in the shader program execution).

The process of the technology described herein could be used only in the case of those shader programs that are known to include an instruction of the particular type. For example, the overall process of providing the shader program for execution could be appropriately provided with an indication of whether or not a shader program includes an instruction of the particular type, with a shader program then being processed in the manner of the technology described herein or not, accordingly.

It could also or instead be the case that the overall process of providing the shader program for execution by a graphics processor includes a step of adding one or more instructions of the particular type to the shader program (in which case it will be known that the shader program should undergo the process of the technology described herein).

Thus in one embodiment, the method of the technology described herein comprises (and the apparatus correspondingly comprises a processing circuit or circuits configured to) adding an instruction of a particular type to a shader program to be executed by a graphics processor, and thereafter generating a control flow graph for the shader program and determining based on the control flow graph whether to move the instruction of the particular type to earlier in the program execution (and then moving the instruction, where appropriate).

Equally, the process of the technology described herein could be used for any and all shader programs (e.g. of a particular type), e.g. irrespective of whether or not it is otherwise indicated that the shader program includes an instruction of the particular type.

In this case, the operation in the manner of the technology described herein in an embodiment includes determining whether a shader program includes an instruction of the particular type (and then processing the shader program accordingly).

Thus, in an embodiment, the method of the technology described herein comprises (and the apparatus correspondingly comprises a processing circuit or circuits configured to) first determining whether a shader program to be executed by a graphics processor includes an instruction of a particular type, and then, when it is determined that the shader program includes an instruction of the particular type, based on a control flow graph for the program, determining whether to move the instruction of the particular type to earlier in the program execution (and when it is determined to move the instruction, then moving the instruction).

In this case, it could be determined whether the shader program includes an instruction of a particular type in any suitable and desired manner (for example, and in an embodiment, using any suitable and desired shader program analysis (compilation) technique. For example, this may be done before or after the control flow graph for the shader program has been generated.

In one embodiment it is determined from the control flow graph whether the shader program includes an instruction of a particular type (and then when it is determined that the shader program includes an instruction of the particular type, it is determined based on the control flow graph whether to move the instruction of the particular type to earlier in the program execution, etc.).

In an embodiment this comprises determining and identifying any basic blocks in the control flow graph for the shader program that contain an instruction or instructions of a particular type (determining whether any of the blocks in the control flow graph contain an instruction of a particular type).

There could just be a single particular type of instruction that is considered for the purposes of the technology described herein, or there could be a set of plural different types of instructions that are all considered in a shader program, as desired.

Thus determining whether to move a particular type of instruction in the shader program to earlier in the shader program execution (and, where appropriate, moving the instruction) could, and in embodiments does, comprise determining whether to move an instruction of any one of a plurality of different types of instruction to earlier in the shader program execution.

The type or types of instruction that are considered in a shader program in this regard can be any suitable and desired type or types of instructions that may be included in a graphics shader program.

In an embodiment, the particular type of instruction is (or includes) a type or types of instructions that it would be desirable to perform early in the shader program where possible (and in an embodiment as early in the shader program execution as possible).

In an embodiment, the type of instruction is a type or types of instruction that could result in the shader program execution being terminated (i.e. such that the particular type of instruction is a type or types of instruction that when executed could result in the shader program execution being terminated (and so for which it would be desirable to execute the instruction earlier, and in an embodiment as early as possible, in the shader program execution, so as to thereby facilitate, where possible, earlier termination of the shader program execution)).

In an embodiment, the particular type of instruction is or includes a type or types of instruction that it would be desirable not to be duplicated in the shader program execution (at least into divergent control flow). In an embodiment, the particular type of instruction is or includes a type or types of instructions that must not be duplicated (that cannot be duplicated) in the shader program execution (at least into divergent control flow), e.g. due to hardware restrictions.

In one embodiment, the particular type of instruction is or includes store instructions. This may be beneficial, for example, to hide latency and/or reduce “register pressure” when executing the shader program, and may, for example, correspondingly be particularly beneficial in the case of compute shader programs.

(In the case of a store instruction, then where a store instruction is moved to earlier in the program execution, that should be (in an embodiment) done so that the instruction is dynamically executed on the same execution paths as before.)

The particular type of instruction may also or instead be or include instructions that have a side effect. The particular type of instruction may also or instead be or include instructions that perform a discard operation.

In an embodiment, the particular type of instruction is or includes instructions that triggers a fragment operation, and in an embodiment, that triggers a fragment culling test operation, such as, and in an embodiment, a depth or stencil test.

The particular type of instruction may also or instead be or include instructions that updates fragment culling information, such as a depth and/or stencil emit instruction.

In an embodiment, the particular type of instruction is or includes instructions that when executed will cause the fragment shader to determine whether an operation can be performed for a fragment being processed, and to, when it is determined that the operation can be performed for a fragment being processed, trigger the performance of the operation for the fragment being processed.

The operation(s) that the instruction (potentially) triggers can be any desired and suitable (fragment) operation or operations. In one embodiment it is an operation that performs a test on the fragment, such as an alpha test, a depth test and/or a stencil test. Thus, in an embodiment, the instruction of the particular type (potentially) triggers a (fragment) test operation (or operations).

In an embodiment, the operation is an operation that will affect and/or determine and in an embodiment that will finalise, the fragment coverage (i.e. the sampling points that are covered (and thus being processed by) the fragment in question).

Thus, in an embodiment, the instruction of the particular type triggers a determination of whether the coverage for the fragment is zero or not (and when it is determined that the coverage for the fragment is zero, then the fragment is in an embodiment discarded (the shader execution for the fragment is halted)).

Correspondingly, in an embodiment, the operation that the instruction of the particular type can trigger is one or more of, and in an embodiment all of: an alpha-to-coverage operation; an alpha test; a stencil test; and a depth test.

It can be determined based on the control flow graph whether to move an instruction of a particular type to earlier in the program execution in any suitable and desired manner.

In an embodiment, this comprises determining there is any other instruction in the shader program that the instruction of the particular type should not be moved before in the program execution (in the control flow graph) (i.e. that should/must be executed before the instruction of the particular type).

Such instructions may, e.g., and in an embodiment, be instructions that would (potentially) conflict with the instruction of the particular type, and/or instructions that the instruction of the particular type is dependent upon (e.g. that one of its operands is dependent on (such as instructions, such as store or discard, that affect an operand for the instruction of the particular type)). For example two store instructions potentially writing to the same memory location would conflict with each other.

Such instructions may also or instead (and in an embodiment also), at least in the case where the instruction of the particular type is a fragment “test” instruction, be instructions that (potentially) modify the fragment coverage (including any “discard” instructions) (i.e. it is preferred for all instructions that modify the fragment coverage to be executed before the (test) instruction is (potentially) executed), and/or instructions that could change the state (such as the fragment alpha value) that the “test” instruction relates to.

Such instructions may also or instead (and in an embodiment also) comprise instructions that have “side effects” (e.g. produce data other than data that passes through the renderer) (i.e. it is preferred for any side effects generated by the shader to occur before the instruction of the particular type is executed).

Thus, in an embodiment, determining based on the control flow graph whether to move an instruction of a particular type to earlier in the program execution comprises determining one or more of, and in an embodiment plural of, and in an embodiment all of: whether there are any instructions that would conflict with the instruction of the particular type; whether there are any instructions that should be executed before the instruction of the particular type; whether there are any instructions that the instruction of the particular type is dependent upon; and whether there are any instructions that have side effects.

When an instruction that should be executed before the instruction of the particular type is identified in the shader program, the position of that instruction relative to the instruction of the particular type is in an embodiment considered. In the case where the “conflicting” instruction (the instruction that must be executed before the instruction of the particular type) immediately precedes the instruction of the particular type in the shader program execution, then it may be, and is in an embodiment, determined that the instruction of the particular type should not be (cannot be) moved to earlier in the program execution. In this case, the process of attempting to move the instruction of a particular type earlier in the program execution may then be, and is in an embodiment, stopped.

In an embodiment, this process is performed by identifying any basic blocks in the control flow graph for the shader program that include any instructions that should (must) be executed before the instruction of the particular type (that “conflict” with the instruction of the particular type), and when the shader program includes blocks including such instructions, considering the position of those blocks relative to the block that includes the instruction of the particular type in the shader program execution (in the control flow graph). Then, in the case where an instruction that conflicts with (e.g. must be executed before) the instruction of the particular type is in a block that immediately precedes the block that contains the instruction of the particular type, it may be, and is in an embodiment, determined that the instruction of the particular type should not be (cannot be) moved to earlier in the program execution.

In an embodiment, as well as considering whether the instruction of the particular type can be moved to earlier in the shader program execution, it is also considered and determined whether any instructions relating to (e.g., and in an embodiment, that create) the operands for the instruction of the particular type would also need to be, and if so, can be, moved to earlier in the program execution.

The Applicants have recognised in this regard, that where the instruction of the particular type has one or more operands, it would also be desirable (and necessary) to maintain any operand dependencies for the instruction of the particular type, and thus to, if necessary, move any instructions (e.g.) creating the operands together with the instruction of the particular type so as to keep any operand dependencies fulfilled.

Thus, in an embodiment, the method of the technology described herein comprises (and the processing circuit(s) are correspondingly configured to) determining whether a (and in an embodiment any) instruction that relates to the operands (if any) of the instruction of the particular type that is being considered also needs to be, and if so, can be, moved to earlier in the program execution or not.

It can be determined whether any “operand” instructions also need to be moved (with the instruction of the particular type) in any suitable and desired manner. For example, any operand instructions that are in the same (basic) block as the instruction of the particular type may be determined as needing to be moved with the instruction of the particular type. For operand instructions in other blocks, it may be, e.g., and in an embodiment, checked whether the operand instructions are after the (earlier) position in the program execution that the instruction of the particular type is (potentially) to be moved to. Other arrangements would, of course, be possible.

It can be determined whether an “operand” instruction can be (or should not be) moved to earlier in the program execution in any suitable and desired manner. This is in an embodiment done in the same way as for the instruction of the particular type, i.e., and in an embodiment, based on one or more of, and in an embodiment plural of, and in an embodiment all of: whether there are any instructions that would conflict with the “operand” instruction; whether there are any instructions that should be executed before the “operand” instruction; whether there are any instructions that the “operand” instruction is dependent upon; and whether there the “operand” instruction has a side effect.

Correspondingly an embodiment, when it is determined that an “operand” instruction related to and for (the) instruction of the particular type should not be (cannot be) moved to earlier in the program execution, then it is and should be, and is in an embodiment, correspondingly determined that the instruction of a particular type should not be (cannot be) moved to earlier in the program execution.

Correspondingly, in an embodiment, it is only determined that an instruction of a particular type can be moved to earlier in the program execution when it is also determined that any “operand” instructions for the instruction of the particular type (that need to be so moved) can also be moved to earlier in the program execution.

When it is determined to move the instruction of the particular type to earlier in the shader program execution, the shader program can be modified in that regard in any suitable and desired manner.

In an embodiment, the moving of the instruction of the particular type to earlier in the shader program execution comprises moving (hoisting) the instruction of the particular type to an earlier block in the shader program execution (in the control flow graph for the shader program). In an embodiment, the instruction of the particular type is moved to a block that dominates the block that the instruction of the particular type was initially present in (i.e. a block in the control flow graph that every path from the entry block for the shader program in the control flow graph that reaches the block that initially contained the instruction of the particular type has to pass through).

Thus, in one embodiment, the determining whether to move the instruction of the particular type to earlier in the shader program execution (and then, where appropriate, modifying the shader program accordingly) based on the control flow graph comprises determining from the control flow graph whether there is a block that dominates the block that contains the instruction of the particular type that the instruction of the particular type could be moved to, and, when so, moving the instruction of the particular type to that dominator block.

This process may, and in an embodiment does, include determining whether the instruction of the particular type can be moved to the dominator block, for example, and in an embodiment, based on whether there are any blocks with instructions that should be executed before the instruction of the particular type between the block that contains the instruction of the particular type and any dominator block for that block.

In the case where there is more than one dominator block for a block containing an instruction of the particular type, then in an embodiment, the instruction of the particular type is moved to the dominator block that is earliest in the shader program execution (and that it is appropriate/suitable to move the instruction of the particular type to).

It would be possible simply to determine whether there is a suitable dominator block to move the instruction of the particular type to, and when there is no suitable dominator block to not modify the shader program (and in one embodiment that is what is done).

However, in an embodiment, the operation in the manner of the technology described herein can also, and in an embodiment does also, operate to insert a new block in the control flow graph, that the instruction of the particular type can be (and is) moved to.

In an embodiment, the operation in the manner of the technology described herein can also, and in an embodiment does also, operate to insert a new block in the control flow graph that dominates the block that contains the instruction of the particular type, that the instruction of the particular type can be (and is) moved to.

This may be, and is in an embodiment, done at least where there is no already suitable existing dominator block in the shader program control flow graph.

Thus, in an embodiment, the method of the technology described herein comprises, in an embodiment in the case where there is no already suitable existing dominator block that the instruction of the particular type can be moved to in the shader program flow control graph, adding a new block (and in an embodiment a new block that dominates the block that contains the instruction of the particular type) in the control flow graph, and moving the instruction of the particular type to that new, e.g. dominator, block.

In these embodiments, the new, e.g. dominator, block that the instruction of the particular type is (to be) included in can be added at any appropriate and desired point in the shader program execution (in the control flow graph for the shader program).

In an embodiment, this new, e.g. dominator, block is added as early as possible in the shader program execution (in the control flow graph for the shader program), (in an embodiment) subject to the presence of any instructions in blocks of the control flow graph (in the shader program) that conflict with it (that should be executed before the instruction of the particular type).

In an embodiment, where a new, e.g. dominator, block is being added to the shader program in this manner, that block is in an embodiment added immediately after a block in the control flow graph that includes an instruction that must be executed before the instruction of the particular type (and in an embodiment immediately after the last block from the start of the program execution that contains an instruction that “conflicts” with the instruction of the particular type).

In these embodiments, as well as creating an earlier, e.g. dominator, block for the block that initially included the instruction of the particular type, where necessary the process also comprises including in (adding to) the flow control graph (one or more) additional “program flow control” blocks that are associated with (e.g. that immediately precede) the new, e.g. dominator, block that is to contain (that contains) the instruction of the particular type.

The Applicants have recognised in this regard that when adding a new, e.g. dominator, block for this purpose, it will still be necessary to ensure that the original program execution flow of the shader program is preserved, notwithstanding the presence of the new, e.g. dominator, block. This being the case, it may be necessary to add additional blocks to the control flow graph that preserve and ensure the original program execution flow, and so, in embodiments, that is done (where necessary).

These additional “control flow” blocks can take any suitable and desired form, and may, for example, and in an embodiment do, include blocks that set flow path parameters that will trigger and ensure the appropriate program flow, together with, for example, and in an embodiment, a block or blocks that can select and trigger the appropriate control flow path, e.g., and in an embodiment, based on a control flow parameter that has been set. For example, a block having multiple exit paths (edges), one of which is selected based on a control flow parameter value, could be, and is in an embodiment, used for this purpose.

It would be possible in this regard to add respective separate blocks to the control flow graph for each of the required control flow operations and the instruction of the particular type, or one or more of those operations could be combined in a single block, where it is appropriate to do that. For example, and in an embodiment, the instruction of the particular type and an appropriate control flow (branch flow) operation could be included in the same (new) control flow graph block, if desired.

In order to add the new dominator block that includes the instruction of the particular type to the control flow graph (and any required control flow blocks), the process of the technology described herein should, and in an embodiment does, move (hoist) the instruction of the particular type to earlier in the shader program, and also add new instructions to the shader program (at the appropriate point), for example, and in an embodiment, for control flow purposes.

Thus, in an embodiment, the operation in the manner of the technology described herein will, and in an embodiment does, accordingly move instruction(s) in the shader program, and/or include (add) additional instructions into the shader program, so as to correspondingly create in the control flow graph for the so-modified shader program, a new block that the instruction of the particular type can be moved to (e.g., and in an embodiment, a (new) dominator block for the block that initially included the instruction of the particular type).

Correspondingly, as well as moving the instruction of the particular type to earlier in the shader program execution, appropriate control flow instructions are in an embodiment also added to the shader program (where required), so as to ensure that the appropriate control flow for the shader program is preserved, notwithstanding that a new, e.g. dominator, block has been added in the control flow graph.

Such modification of the control flow for the shader program execution can be achieved in any suitable and desired manner.

In an embodiment, this is done by including with the instruction of the particular type (in the new, e.g. dominator, block that contains the instruction of the particular type), an appropriate branching instruction that will cause (ensure) the appropriate execution flow (control flow) from that, e.g. dominator, block.

In an embodiment, the branching instruction operates to control the shader program execution flow (i.e. which branch is taken) based on the value of a “branch” variable (control flow parameter) indicating the path that should be taken through the control flow graph. In this case, where appropriate, the modification of the shader program in an embodiment also comprises inserting prior to the branch instruction, instructions (and, in an embodiment, and accordingly, control flow graph blocks) that will set the branch variable (control flow parameter) appropriately so as to ensure the desired shader program flow following the branch instruction.

Thus, in an embodiment, the modifying the shader program to move the instruction of the particular type to earlier in the shader program execution comprises including (adding) a branch instruction and the instruction of the particular type earlier in the shader program execution to form a dominator block for the block that initially included the instruction of the particular type (i.e. moving the instruction of the particular type to the block in the control flow graph that includes the branch instruction).

The operation of the branch instruction, and the setting of the variables to be used as the operand (control variable) for the branch instruction should be, and is in an embodiment, done based on the control flow graph that is generated from the (unmodified) shader program, and so as to preserve (and ensure) the same execution flow through the control flow graph for the shader program after (and notwithstanding) the addition of the new (and earlier), e.g. dominator, block containing the instruction of the particular type.

In an embodiment, the operation in the manner of the technology described herein to, based on the control flow graph for a shader program, determine whether to move an instruction of a particular type to earlier in the program execution and, where appropriate, then modify the shader program so as to include the instruction of the particular type earlier in the program execution comprises:
determining from the control flow graph for the shader program the immediate dominator block for the block that includes the instruction of the particular type, and based on the determined immediate dominator block, determining whether to move the instruction of the particular type to earlier in the shader program execution (and moving the instruction as appropriate).

This may comprise, and in one embodiment does comprise, determining based on the determined immediate dominator block whether to move the instruction of the particular type to the immediate dominator block or not.

In an embodiment this comprises determining, based on the determined immediate dominator block, whether to move the instruction of the particular type to the immediate dominator block, or whether to create a new immediate dominator block to which the instruction is moved (as discussed above) (or whether to not move (to other than move) the instruction of the particular type at all).

In an embodiment, this operation comprises, once the immediate dominator block for the block that contains the instruction of the particular type has been determined:
partitioning the control flow graph between and including the determined immediate dominator block and the block that includes the instruction of the particular type into two sets of blocks, namely a first set (partition) comprising all the blocks that the instruction of the particular type can be hoisted over and another set (partition) comprising the blocks that the instruction of the particular type should not be hoisted over; and
determining the edges (flow paths) that cross the boundary between those two partitions (sets of blocks) (i.e. that go from a block that the instruction of the particular type should not be hoisted to a block that the instruction of the particular type can be hoisted over).

In an embodiment the edges (paths) that cross the boundary (all the edges (paths) (each edge) that originate in a block in the set (partition) comprising the blocks that the instruction of the particular type should not be hoisted over that target a block in the set (partition) of blocks that the instruction of the particular type can be hoisted over) are considered, and based on those edges, it is then determined whether (and if so how) to move the instruction of the particular type to earlier in the program execution.

In an embodiment, this operation comprises determining the edges that cross the boundary between the set of blocks comprising the determined immediate dominator block, and any blocks in the control flow graph between that determined immediate dominator of the block containing the instruction of the particular type and the block containing the instruction of the particular type and that include instructions that conflict with the instruction of the particular type (i.e. blocks over which the instruction of the particular type should not be hoisted) or that point to (that can (statically) reach) a block that includes an instruction that conflicts with the instruction of the particular type (i.e. over which the instruction of the particular type should not be hoisted in the program flow), and the set of blocks in the control flow graph comprising the remaining blocks between the determined immediate dominator block for the block containing the instruction of the particular type, and the block containing the instruction of the particular type and then determining whether to move the instruction of the particular type to earlier in the shader program based on the so determined “edge frontier” (boundary crossing edges).

The determined edge(s) (control flow path(s)) across the boundary are in an embodiment used to determine whether: to not move the instruction of the particular type at all; to move the instruction of the particular type to the identified immediate dominator block; or to create a new dominator block (as discussed above) at the boundary to which the instruction of a particular type can be moved to.

In an embodiment, when the boundary (“edge frontier”) immediately precedes the block that the instruction of a particular type is present in (i.e. there is a block containing an instruction that conflicts with the instruction of the particular type in a block that immediately precedes the block that contains the instruction of the particular type), then it is in an embodiment determined not to move the instruction of the particular type to earlier in the shader program execution (and so the process can be stopped).

On the other hand, correspondingly, in an embodiment, when it is determined that the boundary (“edge frontier”) starts immediately after the determined immediate dominator block (i.e. such that there are no blocks containing conflicting instructions between the immediate dominator block and the block that contains the instruction of the particular type), then it is in an embodiment determined to move the instruction of the particular type to the determined immediate dominator block (and the instruction of the particular type is in an embodiment so moved).

Correspondingly, in the case where it is determined that the boundary (“edge frontier”) lies other than immediately preceding the block that contains the instruction of the particular type or immediately following the determined immediate dominator block (i.e. there is at least one block between the immediate dominator block and the block that contains the instruction of the particular type that contains an instruction that conflicts with the instruction of the particular type), then in an embodiment, a new dominator block is created (together with appropriate control flow blocks) at the boundary (“edge frontier”), with the instruction of the particular type then being moved to that new dominator block.

In this case, the process can then correspondingly be stopped, as the instruction of the particular type will have been moved as early in the shader program execution as it can be.

In the case where the instruction of the particular type was able to be moved to the identified immediate dominator block for that block, then this process is in an embodiment repeated, i.e. with the immediate dominator block for the block that the instruction of the particular type is now present in being identified, and it then being considered, as discussed above, whether the instruction can further be moved to that immediate dominator block or not, etc., accordingly.

In the case where, as discussed above, as well as moving the instruction of the particular type to earlier in the shader program execution, there are also one or more “operand” instructions that need to correspondingly be moved to earlier in the program execution, then the “operand” instructions can correspondingly be moved to earlier in the shader program execution (and to be earlier in the shader program execution than the position the instruction of the particular type is moved to) in any suitable and desired manner. This is in an embodiment done in a corresponding manner to the moving of the instruction of the particular type to earlier in the shader program as discussed above.

In one embodiment, any “operand” instructions are moved together with the instruction of the particular type to the same, earlier, e.g. new, dominator block in the shader program (and included in that block in the appropriate execution order). However, it would also, if desired, be possible to move “operand” instructions to a different block to the instruction of the particular type (e.g. to a different (an earlier) block in the shader program execution than the dominator block that the instruction of the particular type is moved to) (and so in another embodiment, that is what is done).

The operation in the manner of the technology described herein may be performed for a single instruction of a particular type in a shader program, or for plural instructions of a particular type (e.g. for all instructions of a particular type) in a shader program (in the case where the shader program includes more than one instruction of a particular type), as desired.

The operation and processing of a shader program in the manner of the technology described herein can be performed as any suitable and desired part and stage of the overall operation of providing the shader program for execution by a graphics processor, and in and by any suitable and desired stage or component of the overall data (graphics) processing system.

In an embodiment, it is performed as part of and during the overall compilation process that is carried out to provide the shader program in an executable form for a graphics processor.

Correspondingly, in an embodiment, the compiler for the graphics processor performs the operation of the technology described herein. Thus, in an embodiment the shader compiler for the graphics processor performs this operation and/or the respective shader compiler performs this operation, as appropriate (where there are distinct shader compilers).

The compiler may, e.g., and in an embodiment does, run on a host processor of the data/graphics processing system that includes the graphics processor that will execute the shader program (such that the compiler and compiled code run on separate processors within the overall data processing system). However, other arrangements would be possible, such as the compiler running on the same processor as the compiled code, or the compiler being run on a separate processor, such as the program being pre-compiled on a separate system and being distributed in a compiled form.

Thus, in an embodiment the apparatus of the technology described herein comprises and/or is part of a host processor, may, and in an embodiment does, comprise an appropriate programmable processing circuit that can execute a compiler on the host processor.

A shader program to be executed by a graphics processor will typically be provided by the application that requires the graphics processing using a high-level shader programming language, such as GLSL, HLSL, OpenCL, etc., This shader program will consist of “expressions” indicating desired programming steps defined in the relevant language standards (specifications). The high-level shader program is then translated by a shader language compiler to binary code for the target graphics processor that is to execute the shader program. This binary code will consist of “instructions” (hardware micro-instructions) which are specified in the instruction set specification for the given target graphics processor/processing pipeline.

The compilation process for converting the shader language expressions to binary code instructions may take place via a number of intermediate representations of the program within the compiler. Thus, the program written in the high-level shader language may be translated into a compiler specific intermediate representation (and there may be several successive intermediate representations within the compiler), with the final intermediate representation being translated into the binary code instructions for the target graphics processor/processing pipeline.

The processing in the manner of the technology described herein can be performed at any suitable and desired stage of the compilation process, such as on the initial “high-level” representation of the shader program (that is provided by the application that requires the graphics processing), on an intermediate representation of the shader program that has been generated as part of the compilation process, and/or on the final “executable” version of the shader program that is generated by the compilation process, as desired.

Similarly, the modified shader program with the “moved” instruction of the particular type may be created in the form of a higher level shader language program that is then subsequently converted to the necessary instructions for execution on the graphics processor, or may be created directly as a set of instructions to be executed on the graphics processor, or may be created in the form of an intermediate representation that is then converted to the executable instructions for the graphics processor.

In an embodiment, the processing in the manner of the technology described herein is performed on the (application supplied) shader program after the shader program has undergone some, at least initial, (compiler) processing, e.g. for conversion into an executable form for execution by a graphics processor.

In an embodiment, the operation in the manner of the technology described herein is performed after initial processing of the (application supplied) shader program that could add further (additional) instructions to the shader program, for example as part of a compiler optimisation process for the shader program. In an embodiment, the operation in the manner of the technology described herein is performed after any and all (other) processing operations that could result in additional instructions (new instructions) being included in the (application supplied) shader program have been performed.

This may be particularly beneficial in the case where the shader program compilation process itself can include in (add to) an application supplied shader program, instructions of the particular type, e.g., as part of the overall shader program compilation optimisation process. In this case, it would be preferable to perform the processing in the manner of the technology described herein after any instructions of the particular type will have been added to the shader program by the compilation process.

Thus, in an embodiment, the technology described herein is part of an overall shader program compilation process that includes performing shader program optimisations that could add instructions of the particular type to a shader program, and the process of the technology described herein is performed after any such shader program optimisations have been performed during the compilation process (i.e. on a version of the shader program to which instructions of the particular type will have been added (if it was appropriate to do so)).

The modified (e.g. compiled) shader program (program binary) may be provided to a graphics processor for execution in any suitable and desired manner. In an embodiment this is done by storing the appropriately compiled version of the program (the program binary) in memory for access by the graphics processor (and from where it can be accessed by the graphics processor), so that the graphics processor can retrieve the program and execute it when desired.

As well as providing the modified shader program, the process in an embodiment also comprises providing (e.g. storing appropriately in memory) any desired and required metadata, for example in the form of descriptors, headers, etc., relating to the shader program (e.g. to enable its execution).

Once available, the modified program can be, and is in an embodiment, executed by a graphics processor as appropriate. This may be, and is in an embodiment, done as part of a graphics processing operation, for example to perform fragment shading when generating a render output (where the program is a fragment shader program). The execution of the shader program can be triggered and performed in any suitable and desired manner, and is in an embodiment done in the normal manner for the graphics processor and graphics processing system in question.

Thus in an embodiment, the method of the technology described herein further comprises a graphics processor executing the modified shader program when performing graphics processing (when generating a render output).

To facilitate the shader program execution, the graphics processor should, and in an embodiment does, comprise one or more programmable processing (shader) cores each comprising one or more programmable execution units, that are, e.g., and in an embodiment operable to execute shader programs for respective execution threads (each thread representing, e.g., an appropriate work item (such as a fragment in the case of a fragment shading program)). The graphics processor (and processing core) will correspondingly and appropriately comprise appropriate execution thread spawning and scheduling circuits, etc., so as to facilitate this operation.

(As well as any programmable processing (shader) cores, the graphics processor may also contain any other suitable and desired processing units that a graphics processor and graphics processing pipeline may contain, such as a rasteriser, an early depth (or an early depth and stencil) tester, a late depth (or depth and stencil) tester, a blender, a tile buffer, a write out unit, etc.)

As will be appreciated by those skilled in the art, the apparatus of the technology described herein and the graphics processor that is to execute the shader program may be, and is in an embodiment, part of an overall data processing system that will include, e.g., and in an embodiment, a host processor that, e.g., executes applications that require processing by the graphics processor. The host processor will send appropriate commands and data to the graphics processor to control it to perform data processing operations and to produce graphics processing output required by applications executing on the host processor. To facilitate this, the host processor should, and in an embodiment does, also execute a driver for the graphics processing unit, and a compiler or compilers for compiling programs to be executed by the graphics processor.

The apparatus and/or data processing system may comprise, and/or may be in communication with, one or more memories and/or memory devices that store the data described herein, and/or that store software for performing the processes described herein.

The system may comprise, and/or may be in communication with, a display for displaying an output (frame or image) based on the data generated by the graphics processing.

Thus, another embodiment of the technology described herein comprises a data processing system comprising a host processor and a graphics processor, the host processor operable to cause the graphics processor to perform graphics processing tasks to perform graphics processing operations for applications executing on the host processor;
the graphics processor operable to perform graphics processing operations for graphics processing tasks received from the host processor;
the graphics processor configured and operable to execute graphics shader programs when performing graphics processing operations; and
the host processor further comprising an apparatus for providing a shader program for execution by the graphics processor in accordance with the technology described herein.

As will be appreciated by those skilled in the art, this embodiment of the technology described herein can, and in an embodiment does, include any one or more of the features of the technology described herein described herein, as appropriate. For example, the data processing system may, and in an embodiment does, further comprise a memory system in which a shader program for execution by the graphics processor may be stored by the host processor and from which the graphics processor may retrieve the shader program for execution.

The technology described herein can be used for all forms of output that a graphics processing pipeline may be used to generate, such as frames for display, render-to-texture outputs, etc., The output, e.g. fragment shaded data values, from the graphics processing are in an embodiment exported to external, e.g. main, memory for storage and use, such as to a frame buffer for a display.

The technology described herein is applicable to any suitable and desired form or configuration of graphics processor. It is particularly applicable to tile-based graphics processors and graphics processing systems. Thus in an embodiment, the graphics processor and graphics processing pipeline are a tile-based processor and pipeline, respectively.

In an embodiment, the various functions of the technology described herein are carried out on a single graphics processing platform that generates and outputs the rendered fragment data that is, e.g., written to the frame buffer for a display device.

The technology described herein can be implemented in any suitable system, such as a suitably configured micro-processor based system. In an embodiment, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, unless otherwise indicated, the various functional elements and “means” of the technology described herein may comprise a suitable processor or processors, controller or controllers, functional units, circuits/circuitry, processing logic, microprocessor arrangements, etc., that are operable to perform the various functions, etc., such as appropriately dedicated hardware elements and/or processing circuits/circuitry and/or programmable hardware elements and/or processing circuits/circuitry that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuits/circuitry, etc., if desired.

It will also be appreciated by those skilled in the art that all of the described embodiments of the technology described herein can, and in an embodiment do, include, as appropriate, any one or more or all of the features described herein.

The methods in accordance with the technology described herein may be implemented at least partially using software e.g. computer programs. It will thus be seen that when viewed from further embodiments the technology described herein provides computer software specifically adapted to carry out the methods herein described when installed on one or more data processors, a computer program element comprising computer software code portions for performing the methods herein described when the program element is run on at least one data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a graphics processor, renderer or microprocessor system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CD-ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

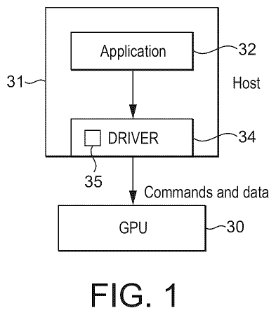

FIG. 1 shows an exemplary computer graphics processing system.

An application 32, such as a game, executing on a host processor 31 will require graphics processing operations to be performed by an associated graphics processing unit (graphics processor) 30. To do this, the application will generate API (Application Programming Interface) calls that are interpreted by a driver 34 for the graphics processor 30 that is running on the host processor 31 to generate appropriate commands to the graphics processor 30 to generate graphics output required by the application 32. To facilitate this, a set of “commands” will be provided to the graphics processor 30 in response to commands from the application 32 running on the host system 31 for graphics output (e.g. to generate a frame to be displayed).

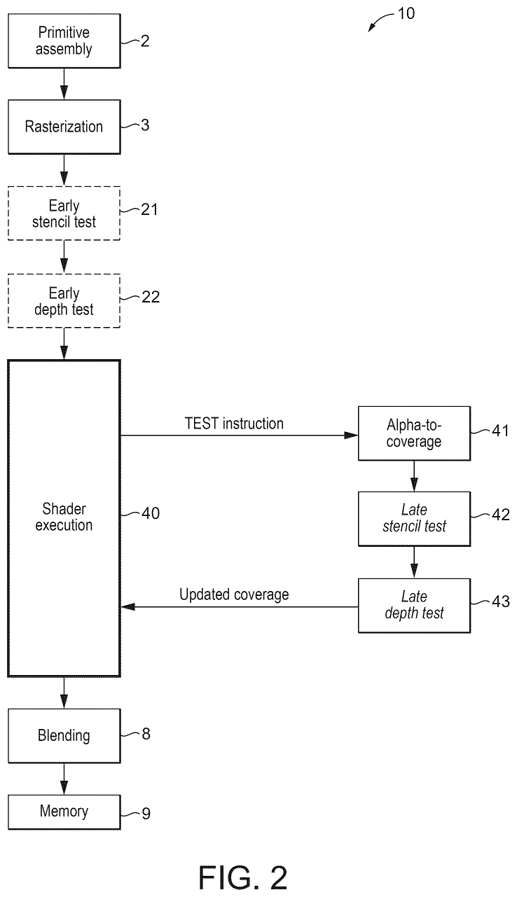

FIG. 2 shows schematically a graphics processing pipeline 10 that may be executed by the graphics processor 30 in an embodiment of the technology described herein.

FIG. 2 shows the main elements and pipeline stages of the graphics processing pipeline 10 that are relevant to the operation of the present embodiments. As will be appreciated by those skilled in the art there may be other elements of the graphics processing pipeline that are not illustrated in FIG. 2. It should also be noted here that FIG. 2 is only schematic, and that, for example, in practice the shown functional units and pipeline stages may share significant hardware circuits, even though they are shown schematically as separate stages in FIG. 2. It will also be appreciated that each of the stages, elements and units, etc., of the graphics processing pipeline as shown in FIG. 2 may be implemented as desired and will accordingly comprise, e.g., appropriate circuits and/or processing logic, etc., for performing the necessary operation and functions.

FIG. 2 shows schematically the pipeline stages starting with the assembly of the graphics primitives (polygons) 2 for input to the rasterisation process. Thus, at this point the graphics data (the vertex data) has undergone geometry frontend operations, such as transformation and lighting operations (not shown). A primitive set-up (assembly) stage 2 then set-ups (assembles) the primitives to be rendered, in response to the commands and vertex data provided to the graphics processor.

As shown in FIG. 2, the graphics processing pipeline 10 then includes a number of further stages, including a rasterisation stage 3, an early stencil test stage 21, an early depth test stage 22, a renderer in the form of a fragment shading stage 40, and a blending stage 8.

The rasterisation stage 3 of the graphics processing pipeline 10 operates to rasterise the primitives making up the render output (e.g. the image to be displayed) into individual graphics fragments for processing. To do this, the rasteriser 3 receives graphics primitives for rendering, rasterises the primitives to sampling points and generates graphics fragments having appropriate positions (representing appropriate sampling positions) for rendering the primitives.

The fragments generated by the rasteriser are then sent onwards to the rest of the pipeline for processing.

The early stencil test stage 21 performs (where appropriate) a stencil test on fragments it receives from the rasteriser 3.

The early depth test stage 22 performs (where possible) a depth test on fragments it receives from the rasteriser 3, to see if any fragments can be discarded (culled) at this stage. To do this, it compares the depth values of (associated with) fragments issuing from the rasteriser 3 with the depth values of fragments that have already been rendered (these depth values are stored in a depth (Z) buffer to determine whether the new fragments will be occluded by fragments that have already been rendered (or not)).

Fragments that pass (or that do not undergo) the fragment early Z and stencil tests are then sent to the fragment shading stage 40. The fragment shading stage 40 performs the appropriate fragment processing operations on the fragments it receives, so as to process the fragments to generate the appropriate rendered fragment data.

In the present embodiment, the fragment shading stage 40 is in the form of a shader pipeline (a programmable fragment shader). The fragment shader 40 is thus a programmable processing stage that executes shader programs on input data values to generate a desired set of output data, e.g. for further processing by the graphics processing pipeline and/or for output.

The fragment processing performed by the fragment shader 40 may include any suitable and desired fragment shading processes, e.g. to apply textures, fogging and other effects to the fragments, to generate the appropriate “fragment shaded” fragment data.

The fragments that complete the fragment shading stage 40 are then subjected to, if required, any necessary blending operations (e.g. shading with other fragments) in a blender 9. Any other remaining operations necessary on the fragments, such as dither, etc. (not shown) are also carried out at this stage.

Finally, the (blended) output fragment data (values) are written to memory 9 from where they can, for example, be output to a frame buffer for a display. (In the case of a tile-based graphics processing pipeline, the output fragment data values may first be written to a tile buffer (not shown) before being written out to main memory 9.)

The writing of the data to memory 9 may include downsampling the fragment data to the appropriate resolution for the output buffer, if desired (e.g. such that an array of pixel data corresponding to the pixels of an output device is generated).

The render output data array may, as is known in the art, typically be an output frame intended for display on a display device, such as a screen or printer, but may also, for example, comprise intermediate data intended for use in later rendering passes (also known as a “render to texture” output), etc.

The process is then repeated for the next render output (e.g. frame) and so on.

Other arrangements for the graphics processing pipeline 10 would, of course, be possible.

The above describes certain features of the operation of the graphics processing pipeline shown in FIG. 2. Further features of the operation of the graphics processing pipeline shown in FIG. 2 in accordance with embodiments of the technology described herein will now be described.

As shown in FIG. 2, in the present embodiments, the fragment shader 40 is operable to, in response to a “test” instruction included in a fragment shader program that it is executing, trigger, if appropriate, the performance of an alpha-to-coverage operation 41, a late stencil test 42, and a late depth test 43 for a fragment being processed, and to then, e.g., return updated coverage information to the fragment shader 40. To do this, the test instruction takes as its inputs, inter alia, the current coverage and an alpha value (and, where appropriate, depth and stencil values) for the fragment and the current graphics processing (render) state, and can provide as an output, inter alia, updated coverage information for the fragment.

This allows alpha-to-coverage and late stencil and depth test operations to be triggered and performed (potentially) during (fragment) shader execution, rather than having, e.g., to wait until (fragment) shader execution has been completed before performing those operations.

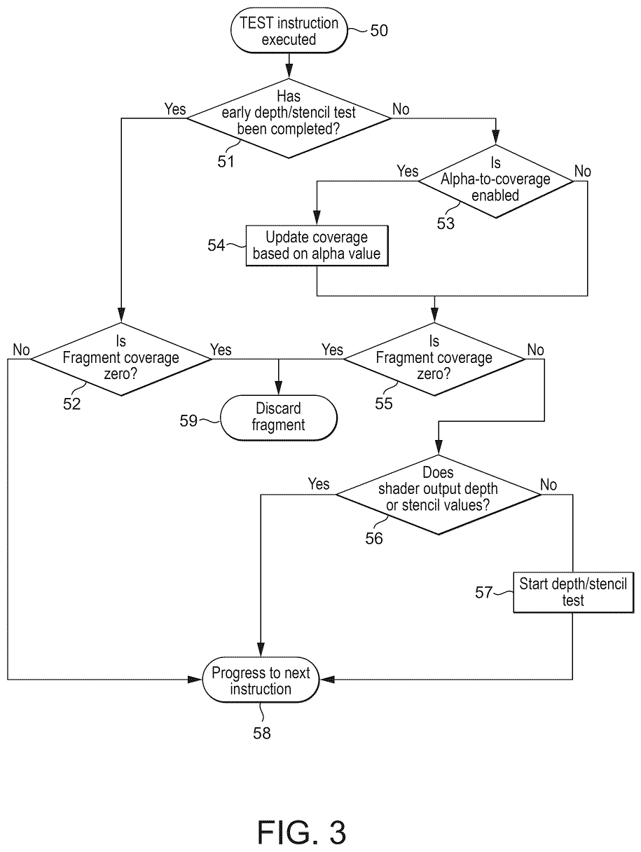

FIG. 3 shows schematically and in more detail the operation of the graphics processing pipeline 10 shown in FIG. 2 when the test instruction is executed (step 50). (The fragment shader 40 when executing a shader program for processing a fragment will execute each instruction in the shader program in turn, but when it reaches the test instruction will operate in the manner described below.)

As shown in FIG. 3, when the test instruction is executed, it is first determined whether the early depth/stencil test has been completed for the fragment being processed (step 51). If the early depth/stencil test has been completed for the fragment in question, it is then determined whether the coverage for the fragment is zero (step 52). If the fragment coverage is determined to be zero, then the fragment is discarded (step 59) (i.e. the fragment shader execution for the fragment in question is halted at this point). On the other hand, if the fragment coverage is determined to be non-zero (i.e. there are still covered sampling positions that the fragment is to be used to render), then the fragment shader execution progresses to the next instruction (step 58).

If the early depth/stencil test has not been completed for the fragment, then it is determined whether alpha-to-coverage operation is enabled (in the state for the graphics processing task being performed) (step 53). If the alpha-to-coverage operation is enabled, then the test instruction triggers the alpha-to-coverage operation and updates the coverage for the fragment based on the alpha value (step 54).

In the present embodiment, the alpha-to-coverage operation is performed by means of dedicated hardware in the fragment shader execution core. Other arrangements for this would be possible. (The alpha-to-coverage operation will proportionally remove coverage for the fragment based on the alpha value for the fragment (and so will, e.g., remove sample positions from the fragment if the alpha value indicates that the fragment is at least partially transparent).)

Once the coverage has been updated (or if the alpha-to-coverage operation is not enabled), it is then determined whether the fragment coverage is zero (step 55). If the fragment coverage is determined to be zero, then the fragment is discarded (step 59) (i.e. the fragment shader execution for the fragment in question is halted at this point).

On the other hand, if the fragment coverage is determined to be non-zero (i.e. there are still covered sampling positions that the fragment is to be used to render), it is then determined whether the shader program is operable to output depth or stencil values (step 56). (Again this can be determined, e.g., from the state for the graphics processing task in question.)

If it is determined that the shader program is to output depth or stencil values, then the execution proceeds to the next instruction for the program (step 58).

If the shader program is not operable to output depth or stencil values (i.e. such that the final depth and stencil values are available at this point), then the test instruction triggers the performance of the depth and/or stencil tests (as appropriate) for the fragment in question (step 57).

In the present embodiment, the depth and stencil tests are performed using depth and stencil test stages of the graphics processing pipeline (thus the test instruction triggers the operation of those stages to perform the depth and stencil test for the fragment). Again, other arrangements would be possible if desired.

If the fragment passes the depth and stencil tests, the shader execution then proceeds to the next instruction in the shader program (step 58). Otherwise, the fragment is discarded (the shader execution for the fragment is stopped) (i.e. if the coverage for the fragment ends up as zero following the depth/stencil test, then the execution of the fragment shader for the fragment in question is stopped (killed) at that point).

In the present embodiments, the test instruction for performing the above operation is included in the fragment shader program for the fragment shader execution stage 40 of the graphics processing pipeline by the shader compiler for the graphics processing pipeline. Furthermore, and in accordance with the technology described herein, the shader compiler operates to try to include the test instruction as early as possible in the fragment shader execution flow.

The compiler may, e.g., run on the host processor 31 of the data processing system that includes the graphics processor 30. (The compiler 35 may, e.g., be part of the driver 4, with there, e.g. being a special API call to cause the compiler to run. The compiler execution can thus be part of the graphics processing preparation done by the driver in response to API calls generated by an application). However, other arrangements would be possible, such as the compiler running on the same processor as the compiled code, or the compiler being run on a separate processor, such as the program being pre-compiled on a separate system and being distributed in a compiled form.

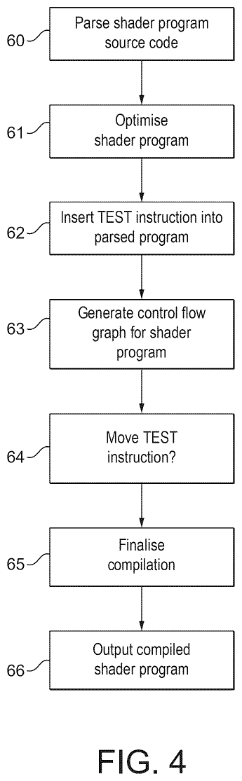

FIG. 4 shows schematically an embodiment of the operation of the compiler to include a test instruction in a shader program to be executed by a fragment shader of a graphics processing pipeline.

The shader compiler will receive a shader program in a high level programming language to be compiled, and, as shown in FIG. 4, first parse the shader program source code and then optimise the shader program (e.g. in accordance with its normal compiler operation) (steps 60 and 61).

The compiler then inserts the test instruction into the parsed program (step 62). This process can be performed in any suitable and desired manner. In an embodiment it is performed in the manner described in the Applicant's U.S. Pat. No. 10,832,464, the entire contents of which is incorporated herein by reference.

Once the test instruction has been inserted into the parsed program, the compiler then generates a control flow graph representing the fragment shader program (step 63), and based on the control flow graph determines whether to move the test instruction to earlier in the shader program execution, and, where appropriate, moves (hoists) the test instruction to earlier in the execution of the shader program to provide a modified shader program, based on the control flow graph (step 64). This operation will be discussed in more detail below.

Once the test instruction has been moved (hoisted) to earlier in the shader program execution (where possible), the compilation of the shader program can be finalised (step 65) and the compiled shader program output to the graphics processor for execution (step 66).

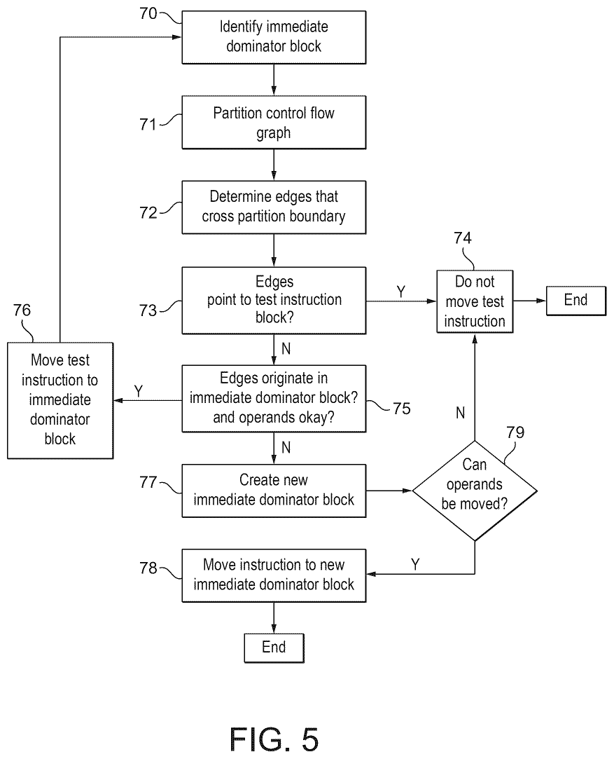

FIG. 5 shows the operation of, based on the control flow graph for a shader program, determining whether to move the test instruction to earlier in the shader program execution, and so-moving the test instruction, when it is determined to do so (step 64 in FIG. 4).

As shown in FIG. 5, this process starts by determining from the control flow graph, the immediate dominator of the block containing the test instruction (step 70).

The control flow graph between and including the determined dominator block and the block that includes the test instruction is then divided into two partitions, one partition representing all the basic blocks that the test instruction can be hoisted over, and the other partition comprising basic blocks that the test instruction should not be hoisted over (step 71).

This is done by determining the set of blocks in the control flow graph comprising the determined immediate dominator of the block containing the test instruction, and any (basic) blocks in the control flow graph between the determined immediate dominator of the block containing the test instruction and the block that contains the test instruction that include instructions that conflict with the test instruction (i.e. basic blocks over which the test instruction should not be hoisted) or that can (statically) reach a basic block that includes an instruction which conflicts with the test instruction (over which the test instruction cannot be hoisted), and the set of blocks in the control flow graph comprising the remaining blocks between the determined immediate dominator block for the block containing the test instruction and the block containing the test instruction.

The “edge frontier”, comprising (all) the edges (flow paths) that cross the boundary between the two partitions (that target a block that the test instruction can be hoisted over from a block that the test instruction should not be hoisted over) (i.e. comprising all edges (flow paths) that originate from a (basic) block in the partition that the test instruction cannot be hoisted over and that target a (basic) block in the partition of the blocks that the test instruction can be hoisted over), is then determined (step 72).

It is then determined whether all of the edges (flow paths) across the boundary point to the block that contains the test instruction (step 73). If so, then it is determined that the test instruction cannot be and should not be moved (hoisted) to earlier in the shader program execution (step 74) (because in this case, all the blocks that immediately precede the block that includes the test instruction will be block(s) that include instructions that conflict with the test instruction or that point to such blocks (i.e. are blocks that the test instruction should not be hoisted over)), and the process is stopped.

When all the edges that cross the boundary do not (other than) point to the block that contains the test instruction, as shown in FIG. 5, it is then determined whether all of the edges (paths) that cross the boundary originate in the determined immediate dominator block of the block that contains the test instruction (step 75).

When all the edges originate in the determined immediate dominator block, then the test instruction can be moved directly to the determined immediate dominator block (step 76) (as this means that there are no conflicting instructions (and thus blocks) between that immediate dominator block and the block that contains the test instruction).

In this case, it is then also checked whether any instructions relating (e.g. creating) any operands to the test instruction can also be moved to the determined immediate dominator block (or all are already before that block in the program execution). If so, it is then “safe” to move the test instruction (and any operand instructions) directly to the determined immediate dominator block, and so that is done. The process is then repeated, starting with determining a new immediate dominator block for the block that now contains the test instruction (at step 70).

(If any “operand” instructions need to be moved, but cannot be moved to the immediate dominator block, then the test instruction will not be moved to that block and the process will terminate.

On the other hand, when all the edges (paths) that cross the boundary do not originate in the determined immediate dominator of the block that contains the test instruction, i.e. such that there is at least one block between the immediate dominator block and the block that contains the test instruction that contains a conflicting instruction (i.e. such that there are some block(s) between the immediate dominator block and the block that contains the test instruction over which the test instruction should not be hoisted), then the process operates to create a new immediate dominator block for the block that contains the test instruction at the control flow graph partition boundary (together with, if necessary, any required control flow blocks) (step 77), checks whether any “operand” instructions can be moved to the new immediate dominator block (step 79) and, if so, then moves the test instruction (and any necessary “operand” instructions) to that new dominator block (step 78). The process is then stopped.

Again, if it is determined that any of the relevant “operand” instructions cannot be moved to the new dominator block, then the process is stopped without moving the test instruction.

This process may be repeated for each instance of a test instruction in a shader program, as desired.

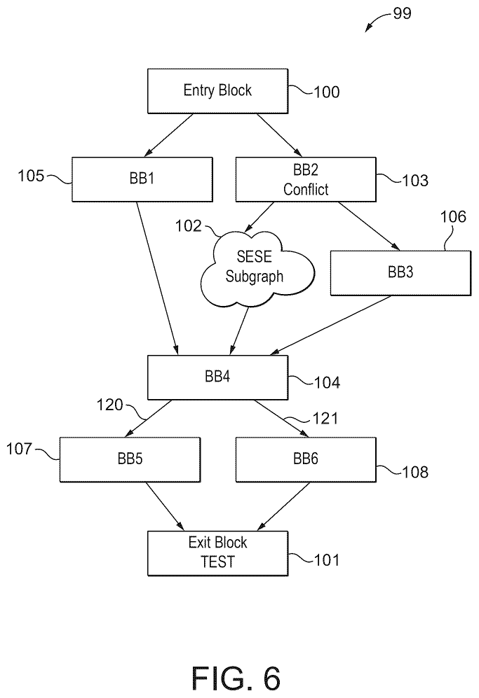

FIGS. 6 to 10 show this operation for an exemplary shader program.

FIG. 6 shows an exemplary control flow graph 99 that is generated for an exemplary shader program after a test instruction has been inserted into the shader program. Thus this control flow graph is an example of the control flow graph that may be generated in step 63 in FIG. 4.

As can be seen from FIG. 6, the control flow graph for this exemplary shader program comprises a single entry block 100 and a single exit block 101. It is assumed in this example that the test instruction is initially present in the exit block 101. The operation in the manner of the present embodiments will accordingly seek to move (hoist) the test instruction from the exit block 101 to earlier in the shader program execution (to try to avoid the execution of any unnecessary instructions before the test instruction, as, as discussed above, the test instruction can potentially trigger an early exit (termination) of the shader program execution).

As shown in FIG. 6, it is assumed that as well as the entry and exit blocks, the control flow graph for the shader program includes a number of basic blocks BB1 105, BB2 103, BB3 106, BB4 104, BB5 107 and BB6 108, and a (potentially large) single entry, single exit (SESE) subgraph 102.

It is also assumed in this example that there is an instruction that conflicts with the test instruction in the basic block BB2 103 (i.e. such that that conflicting instruction must be executed before the test instruction in the program execution flow (where the program execution flow includes executing the conflicting instruction) (i.e. such that the test instruction should not be moved (hoisted) above the basic block BB2 103 that contains the conflicting instruction)).

As discussed above, and as shown in FIG. 5, the operation in the manner of the present embodiments will first determine the immediate dominator block for the exit block 101 that contains the test instruction. In the example shown in FIG. 6, that process will identify the basic block BB4 104 as the immediate dominator of the exit block 101.

As discussed above, the process will then partition the blocks between and including the exit block 101 that contains the test instruction and the basic block BB4 104 that is the immediate dominator of the exit block 101 between blocks that the test instruction can be hoisted over and blocks that the test instruction should not be hoisted over (which partition will comprise the immediate dominating block BB4 104 and any other basic blocks between that block and the exit block 101 that contain instructions that conflict with the test instruction or that statically point to such blocks), and then identify the edges that cross the boundary between those two block partitions (i.e. all the edges that originate from a block in the partition of blocks that the test instruction should not be hoisted over and that target a block in the partition of blocks that the test instruction can be hoisted over).

In the present case, as shown in FIG. 6, there are no “conflicting” blocks between the immediate dominator block BB4 104 and the exit block 101, and so accordingly this process will determine that the edges that cross the partition boundary comprise the edge 120 from the basic block BB4 104 to the basic block BB5 107 and the edge 121 from the basic block BB4 104 to the basic block BB6 108.

Accordingly, as those edges originate in the immediate dominator block BB4 104, it can be and is determined that the test instruction can be moved from the exit block 101 to the immediate dominator block BB4 104.

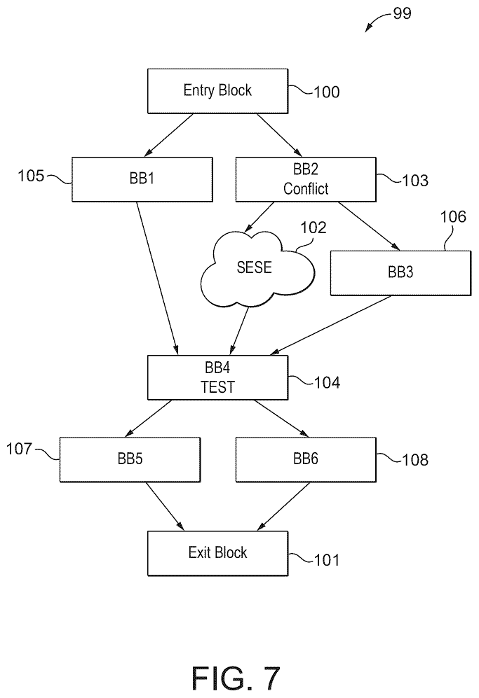

FIG. 7 shows the state of the control flow graph 99 after this operation. As shown in FIG. 7, the test instruction is no longer present in the exit block 101, but is now present in the basic block BB4 104 (and so has been moved to earlier in the shader program execution).

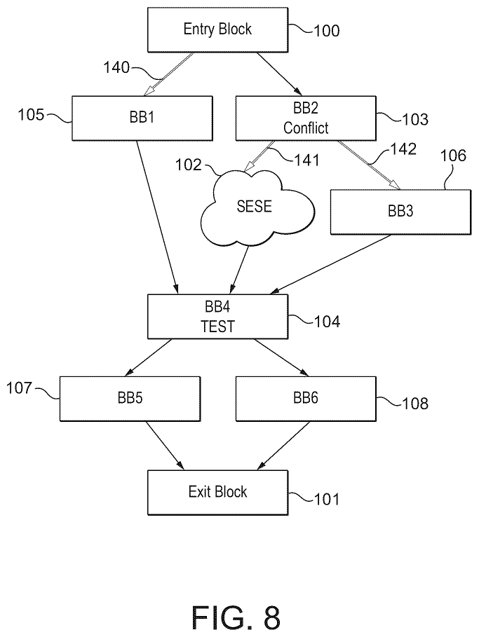

The process is then repeated for the control flow graph in its new form shown in FIG. 7. FIG. 8 illustrates this.

Thus again, the immediate dominator for the basic block BB4 104 that (now) contains the test instruction is first determined. In this case, the immediate denominator for the basic block BB4 104 is the entry block 100, as shown in FIG. 8.

As discussed above, the process will then partition the blocks between and including the basic block BB4 104 that (now) contains the test instruction and the entry block 100 that is the immediate dominator of the basic block BB4 104, between blocks that the test instruction can be hoisted over and blocks that the test instruction should not be hoisted over (which partition will comprise the immediate dominator entry block 100 and any other basic blocks between that block and the basic block BB4 104 that contain instructions that conflict with the test instruction or that statically point to such blocks), and then identify the edges that cross the boundary between those two block partitions.

In this case, the partition of blocks that the test instruction should not be hoisted over will comprise the entry block 100 and the basic block BB2 103 that includes the instruction that conflicts with the test instruction. The remaining blocks are then all blocks that the test instruction can be hoisted over, so blocks BB1 105, the SESE subgraph 102 and the basic block BB3 106 (and all the blocks after those blocks in the control flow graph).

In this case, and as shown in FIG. 8, this process will accordingly determine that the edges that cross the partition boundary comprise the edge 140 between the entry block 100 and the basic block BB1 105, the edge 141 between the basic block BB2 103 that includes the instruction that conflicts with the test instruction and the SESE subgraph 102, and the edge 142 between the basic block BB2 103 and the basic block BB3 106.

This being the case, it will be determined that the test instruction cannot simply be moved (hoisted) to the entry block 100 (as there is a block 103 containing a conflicting instruction between the entry block 100 (which is the current immediate dominator of the block containing the test instruction) and the block BB4 104 that contains the test instruction).

Accordingly, the control flow graph is restructured by inserting a new dominator block for the basic block BB4 104 where the test instruction resides based on the determined control flow graph boundary (“edge frontier”) between the two partitions of the control flow graph.

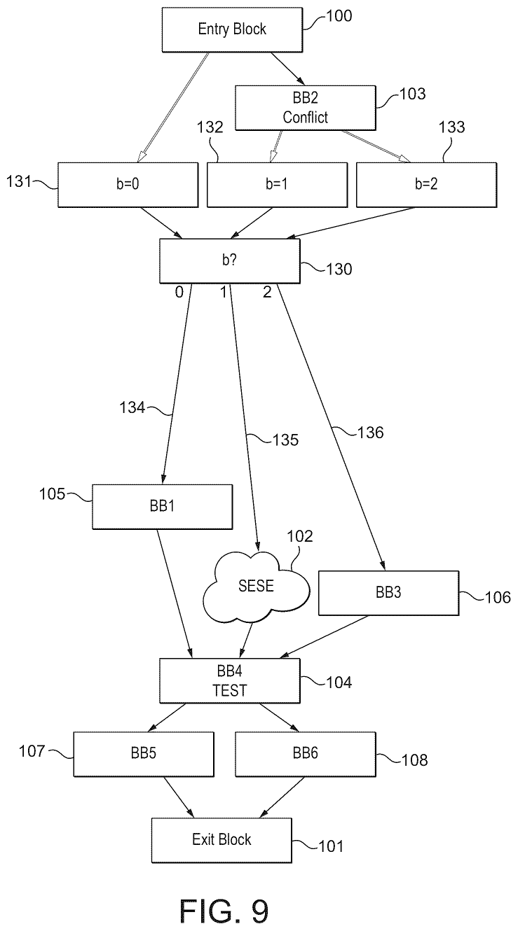

FIG. 9 illustrates this, and shows the inclusion of a new dominator block b? 130 in the control flow graph at the boundary between the partition comprising the entry block 100 and the basic block BB2 103 that contains the instruction that aliases with the test instruction, and the remaining basic blocks in the control flow graph.

As shown in FIG. 9, the new dominator block b? 130 becomes a new immediate dominator of basic block BB4 104.

As shown in FIG. 9, as well as inserting the new dominator block b? 130, new respective basic blocks 131, 132, 133 are also inserted as respective new targets for each edge that crosses the partition boundary (for each edge in the control flow graph edge frontier), which new target basic blocks assign a respective edge number to a flow control variable b (such that a different value will be assigned to the control flow variable b based on which edge crossing the partition boundary and targeting the new dominator block b? 130 the program flow has followed to that point).

The new dominator block b? 130 is correspondingly configured, as shown in FIG. 9, to have respective edges 134, 135 and 136 exiting from that basic block that are correspondingly selected as the flow path through the program based on the assigned control flow variable value b.

In other words, the edges crossing the partition boundary are enumerated, and for each edge, a new block is inserted as the new target of the edge that assigns the edge number to a variable (b), which variable is then checked in the new immediate dominator block 130, such that depending on the value of the variable, the correct path to the target block is taken.

This is done based on and to ensure that the program flow through the shader program execution is preserved, notwithstanding the restructuring of the control flow graph (i.e. such that although the structure of the control flow graph has been changed, it is still semantically the same as the original control flow graph).

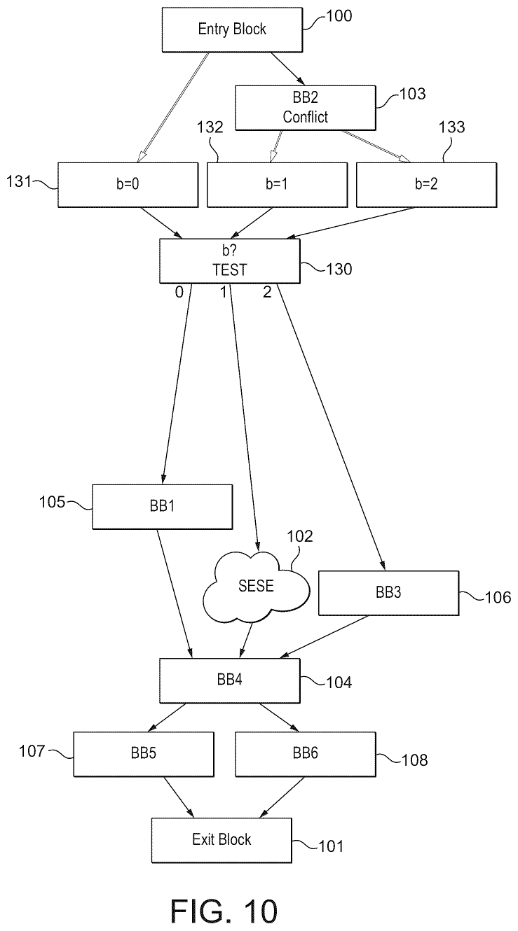

After this, the test instruction can be moved (hoisted) to the new dominator block b? 130 (and accordingly above the potentially large SESE subgraph 102), as shown in FIG. 10.

In this case, as a new dominator block has been created, the process of attempting to hoist the test instruction is stopped, as the test instruction has been hoisted as early as it can in the shader program execution.

The following are exemplary algorithms for performing the processes described above with reference to FIGS. 5 to 10.

Algorithm 1 below is an exemplary main algorithm for hoisting (moving) an instruction I of a particular type.

Algorithm 1

| | |
|---|---|
| 1: | procedure Hoist(I, HoistTarget) |
| 2: | Bottom ← GetBasicBlock(I) |
| 3: | Frontier ← ComputeCfgEdgeFrontier(I, HoistTarget) |
| 4: | if AllCfgEdgesHaveTarget(Frontier, Bottom) then |
| 5: | return |
| 6: | end if |
| 7: | if AllCfgEdgesHaveSource(Frontier, HoistTarget) then |
| 8: | NewHoistTarget ← HoistT arget |
| 9: | else |
| 10: | NewHoistTarget ← CreateNewHoistTarget(Frontier) |
| 11: | end if |
| 12: | if CanHoistInstructionWithOperands(I, NewHoistTarget) then |
| 13: | HoistInstructionWithOperands(I, NewHoistTarget) |
| 14: | end if |
| 15: | end procedure |

In this algorithm, the Hoist procedure takes as input the instruction I that it is desired to hoist, and the basic block HoistTarget that is the basic block that the instruction I is to be attempted to be hoisted into, which in the present embodiment, as discussed above, is found by determining the immediate dominator of the basic block (Bottom) that contains the instruction I.

The algorithm first computes the control flow graph “edge frontier” (the edges crossing the partition boundary for the control flow graph) (line 3) (which is determined using Algorithm 2 as shown below).

If all the frontier edge targets point to the basic block that contains the instruction I (Bottom), then there is nothing that can be done (lines 4-5) and the process ends (as this means that the instruction I could not be hoisted over any predecessor basic block of “Bottom” (the basic block that contains the instruction I)).

If all the edges originate in HoistTarget (the immediate dominator of the basic block that contains the instruction I), then it means that the instruction I can be moved directly to “HoistTarget” as no other instruction interferes (lines 7-8).

Otherwise, a new hoist target block, NewHoistTarget is created along the control flow graph edge frontier (lines 10-11).

In lines 13-14, it is checked whether all the operands of I can actually be hoisted to NewHoistTarget, and if so, the hoisting is performed. (As discussed above, it might be that some operands of I can not be hoisted to NewHoistTarget, e.g. as they are operations with side-effects. In this case, the hoisting would not be performed.)

Algorithm 2 below shows the computation of the control flow graph “edge frontier”.

Algorithm 2

| | |
|---|---|
| 1: | procedure ComputeCfgEdgeFrontier(I, HoistTarget) |
| 2: | Sentinels ← ComputeSentinelBlocks(I, HoistTarget) |
| 3: | return ExtractCfgEdgeFrontier(Sentinels) |
| 4: | end procedure |
| 5: | procedure ComputeSentinelBlocks(I, HoistTarget) |
| 6: | Bottom ← GetBasicBlock(I) |
| 7: | Sentinels ← Ø |
| 8: | repeat |
| 9: | ToVisit ← IncomingEdges(Bottom) |
| 10: | Visited ← Ø |
| 11: | while ToVisit ≠ Ø do |
| 12: | (Source, Target) ← Pop(ToVisit) |
| 13: | Visited ← Visited ∪ (Source, Target) |
| 14: | if CanMoveOverBlock(I, Source) = False or Target ∈ |
| | Sentinels or Source = HoistTarget then |
| 15: | Sentinels ← Sentinels ∪ Source |
| 16: | end if |
| 17: | for all E ∈ IncomingEdges(Source) do |
| 18: | if E ∉ Visited then |
| 19: | ToVisit ← ToVisit ∪ E |
| 20: | end if |
| 21: | end for |
| 22: | end while |
| 23: | until Sentinels does not change |
| 24: | return Sentinels |
| 25: | end procedure |
| 26: | procedure ExtractCfgEdgeFrontier(Sentinels) |
| 27: | Frontier ← Ø |
| 28: | for all S ∈ Sentinels do |
| 29: | for all (Source, Target) ← OutgoingEdges(S) do |
| 30: | if Source ∈ Sentinels and Target ∉ Sentinels then |
| 31: | Frontier ← Frontier ∪ (Source, Target) |
| 32: | end if |
| 33: | end for |
| 34: | end for |
| 35: | return Frontier |
| 36: | end procedure |

In this algorithm, the ComputeCfgEdgeFrontier procedure takes as input the instruction I that is supposed to be hoisted, and the basic block HoistTarget (the immediate dominator of the block that contains the instruction I) that is the target of the hoisting transformation.

This algorithm first computes the “sentinel” basic blocks over which the instruction I should not be hoisted (line 2). As discussed above, in the present embodiments, the “sentinel” blocks are all the basic blocks:
1. over which I cannot be hoisted due to conflicting instructions;
2. that can statically reach a sentinel block; or
3. that are the HoistTarget (the immediate dominator of the block that contains the instruction I).

If HoistTarget is the only sentinel block, then ExtractCfgEdgeFrontier( ) returns the outgoing edges of HoistTarget, otherwise ExtractCfgEdgeFrontier( ) returns all edges that originate in a sentinel block and target a non-sentinel block.

The procedure ComputeSentinelBlocks is a simple fixed-point iteration that iterates over all the basic blocks between the basic block that contains the instruction I (Bottom (line 6)) and HoistTarget. Lines 15-16 determine whether a basic block is a sentinel block and, if so, adds it to the sentinel set.

Algorithm 3 below shows the process for creating the NewHoistTarget basic block (a new immediate dominator block for the block that contains the instruction I).

Algorithm 3

| | |
|---|---|
| 1: | procedure CreateNewHoistTarget(Frontier) |
| 2: | NewHoistTarget ← CreateBasicBlock( ) |
| 3: | V ← CreateVariable( ) |
| 4: | CreateBranch(NewHoistTarget, V) |
| 5: | EdgeNr ← 0 |
| 6: | for all (Source, Target) ← Frontier do |
| 7: | Incoming ← CreateBasicBlock( ) |
| 8: | A ← CreateAssignment(V, EdgeNr) |
| 9: | AddAssignment(Incoming, A) |
| 10: | AddEdge(Incoming, NewHoistTarget, 0) |
| 11: | AddEdge(NewHoistTarget, Target, EdgeNr) |
| 12: | ReplaceOutgoingEdge(Source, Target, Incoming) |
| 13: | ReplaceIncomingEdge(Target, Source, NewHoistTarget) |
| 14: | EdgeNr ← EdgeNr + 1 |
| 15: | end for |
| 16: | end procedure |

In this algorithm the CreateNewHoistTarget procedure takes the CFG edge frontier as input and creates a NewHoistTarget basic block along the CFG edge frontier (line 2) and inserts a branch into that basic block that acts on the value of variable V (lines 3-4) (thus creating the “star structure” as depicted in FIG. 9). The value of V determines which outgoing edge of NewHoistTarget to take, dispatching the control flow to the original target.

For each edge in the edge frontier, the algorithm performs the following:
1. Inserts a basic block “Incoming” that contains an assignment V=EdgeNr (lines 7-9);
2. Inserts the edges (Incoming, NewHoistTarget) (line 10) and (NewHoistTarget, Target) (line 11); and
3. Removes edge (Source, Target), and inserts edges (Source, Incoming) as well as (NewHoistTarget, Target) (line 12-13).

It will be appreciated that in the above example, the potential “hoist target” is first determined, and it is then determined whether any relevant operand instructions can be hoisted to that target (and if that is the case, then the test instruction and any operand instructions are so hoisted (but if not, the hoisting is not done)).

It would also be possible, if desired, to determine whether the relevant instruction operands can be hoisted above the control flow graph “edge frontier” before creating a new hoist target basic block. In that case, if the instruction of the particular type and the relevant operand instructions can be hoisted above the “edge frontier”, then a new hoist target basic block will be created and the instruction and the operand instructions will be hoisted to that block (or, if not, then the instruction of the particular type will not be hoisted).

The following algorithms 4 to 8 are exemplary algorithms for “hoisting” an instruction in this manner.

Algorithm 4 below is an exemplary main algorithm for hoisting (moving) an instruction I of a particular type.

Algorithm 4

| | |
|---|---|
| 1: | procedure Hoist(I, HoistTarget) |
| 2: | Sentinels, NonSentinels ← PartitionSubgraph(I, HoistTarget) |
| 3: | if NonSentinels = Ø then |
| 4: | return |
| 5: | end if |
| 6: | if CanHoistOperands(I, Sentinels, NonSentinels) = False then |
| 7: | return |
| 8: | end if |
| 9: | if Sentinels = Ø then |
| 10: | NewHoistTarget ← HoistTarget |
| 11: | else |
| 12: | Frontier ← ExtractCfgEdgeFrontier(Sentinels) |
| 13: | NewHoistTarget ← CreateNewHoistTarget(Frontier) |
| 14: | end if |
| 15: | HoistInstructionWithOperands(I, NewHoistTarget) |
| 16: | end procedure |

In this algorithm, the Hoist procedure takes as input the instruction I that it is desired to hoist, and the basic block HoistTarget that is the basic block that the instruction I is to be attempted to be hoisted into, which in the present embodiment, as discussed above, is found by determining the immediate dominator of the basic block that contains the instruction I.

This “Hoist” algorithm performs the following operations:
1. Line 2: Partition the subgraph defined by I's basic block and its dominator HoistTarget into sentinel and non-sentinel basic blocks (this is done using algorithm 5 as shown below).
2. Lines 3-5: Checks if any non-sentinel basic blocks were found at all. If no non-sentinel blocks were found, then I cannot even be hoisted to the top of its block, i.e., there is another instruction above in the block that conflicts with I. The process can immediately return from Hoist as no hoisting can be done at all.
3. Lines 6-8: Checks if it is also possible to hoist the operands of I above the CFG “edge frontier” (this is determined using algorithm 6 as shown below). If this is not the case, the process can also return from Hoist as nothing can be done.
4. Lines 9-14: If no sentinels could be found, it means that I can be hoisted into HoistTarget. Otherwise, it is necessary to create a NewHoistTarget along the CFG “edge frontier” to serve as a new hoist target for I (this is done using algorithms 7 and 8 as shown below);
5. Line 15: Hoist instruction I along with its operands to NewHoistTarget.

Algorithm 5 below performs the partitioning of the subgraph of basic blocks between the entry block HoistTarget and the exit block Bottom containing the instruction of the particular type I into “sentinels” and “non-sentinels”. Sentinel blocks are all basic blocks:
1. over which I cannot be hoisted due to conflicting instructions, and
2. all basic blocks that can statically reach a sentinel block.

All other basic blocks in the subgraph are non-sentinels.

Algorithm 5

| | |
|---|---|
| 1: | procedure PartitionSubgraph(I, HoistTarget) |
| 2: | Bottom ← GetBasicBlock(I) |
| 3: | if CanMoveToTopOfBlock(I) = False then |
| 4: | Sentinels ← CollectBlocksBetween(Bottom, HoistTarget) |
| 5: | return Sentinels, Ø |
| 6: | end if |
| 7: | Sentinels ← Ø |
| 8: | NonSentinels ← {Bottom} |
| 9: | repeat |
| 10: | Visited ← IncomingEdges(HoistTarget) |
| 11: | ToVisit ← IncomingEdges(Bottom) |
| 12: | while ToVisit ≠ Ø do |
| 13: | (Source, Target) ← Pop(ToVisit) |
| 14: | Visited ← Visited ∪ (Source, Target) |
| 15: | if CanMoveOverBlock(I, Source) = False or Target ∈ |
| | Sentinels then |
| 16: | Sentinels ← Sentinels ∪ Source |
| 17: | end if |
| 18: | for all E ∈ IncomingEdges(Source) do |
| 19: | if E ∉ Visited then |
| 20: | ToVisit ← ToVisit ∪ E |
| 21: | end if |
| 22: | end for |
| 23: | end while |
| 24: | until Sentinels does not change |
| 25: | for all (Source, Target) ← Visited do |
| 26: | if Target ∉ Sentinels then |
| 27: | NonSentinels ← Target ∪ NonSentinels |
| 28: | end if |
| 29: | end for |
| 30: | return Sentinels, NonSentinels |
| 31: | end procedure |

In this algorithm, the PartitionSubgraph procedure takes as input the instruction I that it is desired to hoist, and the basic block HoistTarget that is the basic block that the instruction I is to be attempted to be hoisted into.

The algorithm performs the following:
1. Lines 3-6: These lines check if instruction I can be moved to the top of its basic block, i.e., there is no instruction above it in the basic block that conflicts with it. If it cannot be moved to the top of its basic block, then all basic blocks in the subgraph must be sentinels. All these blocks are collected and returned, as well as an empty set for the non-sentinels.
2. Lines 7-8: Initialize the necessary sets for the partitioning determination that follows. At this point, it is known that Bottom cannot be a sentinel.
3. Lines 10-24: Computes all sentinels in the subgraph. It is a fixed-point iteration that continues until no new sentinels can be found:
   Lines 10-11: Initializes the ToVisit set with the incoming edges of I's basic block, i.e., Bottom. Moreover, the Visited set is initialised with the incoming edges of HoistTarget to ensure that the graph traversal is stopped at HoistTarget and does not go “above it”.
   Lines 13-14: Gets the next candidate edge from ToVisit and marks it as visited.
   Lines 15-17: If I cannot be moved over the source of the current edge due to conflicting instructions (point one in sentinel definition) or if the edge's target is a sentinel (point two in sentinel definition), then the edge's source is a sentinel.
   Lines 18-22: Updates the ToVisit set with the incoming edges of the current edge's source basic block, but only if we have not visited the edges yet.
4. Lines 25-29: Computes the NonSentinels set. It is the set of all visited basic blocks in the subgraph minus the set of sentinel basic blocks.

Algorithm 6 shows the procedure for checking the operands of the instruction I that it is desired to “Hoist”.

Algorithm 6

| | |
|---|---|
| 1: | procedure CanHoistOperands(I, NonSentinels) |
| 2: | for all Operand ∈ GetOperands(I) do |
| 3: | if CanHoistOperandHelper(Operand, NonSentinels) == False |
| | then |
| 4: | return False |
| 5: | end if |
| 6: | end for |
| 7: | return True |
| 8: | end procedure |
| 9: | procedure CanHoistOperandHelper(I, NonSentinels) |
| 10: | BB ← GetBasicBlock(I) |
| 11: | if BB ∉ NonSentinels then |
| 12: | return True |
| 13: | end if |
| 14: | if IsMemoryInstruction(I) then |
| 15: | return False |
| 16: | end if |
| 17: | for all Operand ∈ GetOperands(I) do |
| 18: | if CanHoistOperandHelper(Operand, NonSentinels) == False |
| | then |
| 19: | return False |
| 20: | end if |
| 21: | end for |
| 22: | return True |
| 23: | end procedure |

This CanHoistOperands function takes the instruction I and the set of non-sentinels to check whether all the operands of I can be hoisted above the CFG “edge frontier”.

This algorithm performs the following:
1. Lines 2-6: Iterates through all the operands of an instruction, invoking CanHoistOperandHelper to check whether an operand can be hoisted.
2. Lines 11-13: Checks whether the instruction's basic block is not within the nonsentinel set, i.e., whether the basic block is a sentinel or above the subgraph that is inspected. If that is the case, then there is no need to hoist this operand as it is already “above in the graph”.
3. Lines 14-16: If the instruction is a memory instruction, then it cannot be hoisted, as it might conflict with other instructions that are between the instruction and the hoist target.
4. Lines 17-21: Recursively invokes CanHoistOperandHelper for the operands of the current instruction.

Algorithm 7 below performs the extraction of the CFG “edge frontier” from the sentinel basic blocks.

Algorithm 7

| | |
|---|---|
| 1: | procedure ExtractCfgEdgeFrontier(Sentinels) |
| 2: | Frontier ← Ø |
| 3: | for all S ∈ Sentinels do |
| 4: | for all (Source, Target) ← OutgoingEdges(S) do |
| 5: | if Source ∈ Sentinels and Target ∉ Sentinels then |
| 6: | Frontier ← Frontier ∪ (Source, Target) |
| 7: | end if |
| 8: | end for |
| 9: | end for |
| 10: | return Frontier |
| 11: | end procedure |

The ExtractCfgEdgeFrontier procedure takes the set of basic block sentinels as input and returns the CFG “edge frontier” set.

This algorithm performs the following:
1. Line 2: Initializes the CFG edge frontier to the empty set.
2. Lines 3-4: Iterates through all the outgoing edges of all sentinels.
3. Lines 5-7: If the source of an edge is a sentinel and its target is not a sentinel, then it must be a frontier edge. It is added to the CFG edge frontier set.

Algorithm 8 below performs the creation of the new hoist target along the CFG edge frontier.

Algorithm 8

| | |
|---|---|
| 1: | procedure CreateNewHoistTarget(Frontier) |
| 2: | NewHoistTarget ← CreateBasicBlock( ) |
| 3: | V ← CreateVariable( ) |
| 4: | CreateBranch(NewHoistTarget, V) |
| 5: | EdgeNr ← 0 |
| 6: | for all (Source, Target) ← Frontier do |
| 7: | Incoming ← CreateBasicBlock( ) |
| 8: | A ← CreateAssignment(V, EdgeNr) |
| 9: | AddAssignment(Incoming, A) |
| 10: | AddEdge(Incoming, NewHoistTarget, 0) |
| 11: | RedirectOutgoingEdge(Source, Target, Incoming) |
| 12: | AddEdge(NewHoistTarget, Target, EdgeNr) |
| 13: | EdgeNr ← EdgeNr + 1 |
| 14: | end for |
| 15: | end procedure |

This CreateNewHoistTarget procedure takes the CFG edge frontier as input and creates NewHoistTarget along the CFG edge frontier. It creates the “star structure” as depicted in FIG. 9.

This algorithm performs the following:
1. Lines 2-4: Creates the new hoist target basic block along with a branch in it that routes control flow to the correct non-sentinel block depending on the value of V.
2. Lines 6-14: Iterates through each of the frontier edges and performs the following:
   Lines 7-9: Creates a new basic block with an assignment of the unique edge identifier EdgeNr to V. This identifier determines the control path taken by the branch in the new hoist target.
   Line 10: Adds an edge from the new basic block Incoming to the new hoist target, NewHoistTarget.
   Line 11: Redirects the edge (Source, Target) to be (Source, Incoming).
   Line 12: Adds a new edge from NewHoistTarget to Target with identifier EdgeNr.
   Line 13: Increments the edge identifier for the next edge.

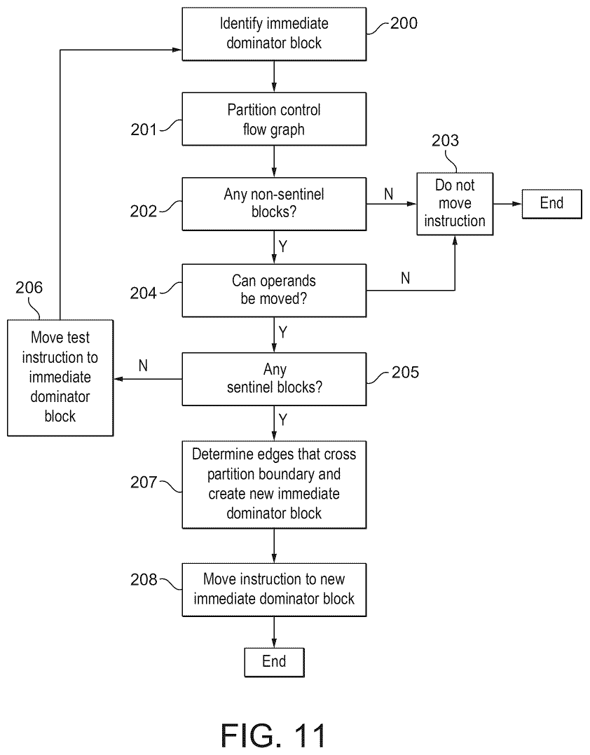

FIG. 11 illustrates the operation in this embodiment.

As shown in FIG. 11, the process starts by determining from the control flow graph, the immediate dominator of the block containing the test instruction (step 200).

The control flow graph between and including the determined dominator block and the block that includes the test instruction is then patitioned into sentinel and non-sentinel blocks (step 201). As discussed above, sentinel blocks are basic blocks over which the instruction cannot be hoisted due to conflicting instructions and all blocks that can statically reach a sentinel block.

If there are no non-sentinel basic blocks at all (step 202), then the instruction cannot be hoisted (step 203), and so the process is stopped.

On the other hand, if there are non-sentinel blocks, it is then determined whether the operands of the instruction being considered can be hoisted (step 204). Again, if this is not possible, then the instruction cannot be hoisted (step 203) and so the process is stopped.

If the operands and the instruction can be hoisted, it is then determined whether there are any sentinel blocks at all (step 205).

If not, the instruction (and its operands) can be hoisted to the immediate dominator block (step 206). The process is then repeated, starting with determining a new immediate dominator block for the block that now contains the test instruction (at step 200).

On the other hand, if some sentinel blocks exist, then the CFG “edge frontier” is determined and a new dominator block for hoisting the instruction and its operands to is created at the “edge frontier” (step 207).

The instruction and its operands are then hoisted to that new dominator block (step 208) (and the process ends).

The above embodiments describe the particular operation steps for the operation in the manner of the technology described herein. It will be appreciated by those skilled in the art that depending on the properties of the control flow graph that is generated, for example, additional transformation steps may need to be taken. For example, for control flow graphs in SSA form, the following additional steps may need to be taken: adjustment of the operands of phi operations and the insertion of new phi operations in NewHoistTarget to ensure that SSA form invariants are met.

Although the present embodiments have been described above with reference to the test instruction as being the particular type of instruction that is attempted to be moved (hoisted) in the shader program in the manner of the present embodiments, the operation in the manner of the present embodiments can equally be performed and implemented in respect of other types of instructions that it may be desirable to move (hoist) to earlier in a shader program execution. Thus, the above described operation of the present embodiments may correspondingly be applied to other types of instructions that may be present in a shader program, as desired.

It will be appreciated from the above, that in its embodiments at least, the technology described herein facilitates moving (hoisting) desired instructions to earlier in a shader program, such that those instructions may be, where possible, executed earlier in the shader program execution. This may then be beneficial, for example, in facilitating earlier termination of the shader program execution in use.

This is achieved, in the embodiments of the technology described herein at least, by using a control flow graph for a shader program to determine whether and how to move a desired instruction to earlier in the shader program execution.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

What is claimed is:

1. A method of providing a shader program for execution by a graphics processor that is operable to execute graphics shader programs, the method comprising:
generating a control flow graph for a shader program to be executed by a graphics processor;
based on the control flow graph:
determining whether to move an instruction of a particular type to earlier in the program execution; and
when it is determined to move the instruction of the particular type to earlier in the program execution, modifying the shader program so as to move the instruction of the particular type earlier in the program execution; and
providing the modified shader program for execution by a graphics processor.

2. The method of claim 1, wherein the graphics shader program is a fragment shading program.

3. The method of claim 1, comprising:
including an instruction of a particular type in a shader program to be executed by a graphics processor; and
thereafter:
generating a control flow graph for the shader program;
based on the control flow graph:
determining whether to move the instruction of a particular type to earlier in the program execution; and
when it is determined to move the instruction of the particular type to earlier in the program execution, modifying the shader program so as to move the instruction of the particular type earlier in the program execution; and
providing the modified shader program for execution by a graphics processor.

4. The method of claim 1, wherein the instruction of a particular type is one or more of:
an instruction is a type or types of instruction that could result in the shader program execution being terminated;
an instruction that should not to be duplicated in the shader program execution;
a store instruction;
an instruction that has a side effect;
an instruction that triggers a fragment operation;
an instruction that triggers a fragment culling test operation;
an instruction that updates fragment culling information; and
an instruction that when executed will cause the fragment shader to determine whether a an operation can be performed for a fragment being processed, and to, when it is determined that the operation can be performed for a fragment being processed, trigger the performance of the operation for the fragment being processed.

5. The method of claim 1, wherein determining based on the control flow graph whether to move an instruction of a particular type to earlier in the program execution comprises at least one of:
determining whether there are any instructions that would conflict with the instruction of the particular type;
determining whether there are any instructions that should be executed before the instruction of the particular type;
determining whether there are any instructions that the instruction of the particular type is dependent upon; and
determining whether there are any instructions that have side effects.

6. The method of claim 1, wherein modifying the shader program so as to move the instruction of the particular type earlier in the program execution comprises:
moving the instruction of the particular type to a block in the control flow graph that dominates the block that the instruction of the particular type was present in.

7. The method of claim 1, wherein modifying the shader program so as to move the instruction of the particular type earlier in the program execution comprises:
creating a new block in the control flow graph and moving the instruction of the particular type to that new block in the control flow graph.

8. The method of claim 1, wherein modifying the shader program so as to move the instruction of the particular type earlier in the program execution comprises:
as well as moving the instruction of the particular type to earlier in the shader program execution, adding instructions to the shader program to control the program flow through the modified shader program.

9. The method of claim 1, wherein determining, based on the control flow graph, whether to move the instruction of a particular type to earlier in the program execution; and when it is determined to move the instruction of the particular type to earlier in the program execution, modifying the shader program so as to move the instruction of the particular type earlier in the program execution comprises:
determining from the control flow graph for the shader program the immediate dominator block for the block that includes the instruction of the particular type, and based on the determined immediate dominator block, determining whether to move the instruction of the particular type to earlier in the shader program execution.

10. The method of claim 9, comprising, once the immediate dominator block for the block that contains the instruction of the particular type has been determined:
partitioning the blocks of the control flow graph between and including the determined immediate dominator block and the block that includes the instruction of the particular type into two sets of blocks, a first set comprising all the blocks that the instruction of the particular type can be hoisted over and another set of blocks comprising the blocks that the instruction of the particular type should not be hoisted over;
determining the edge(s) in the control flow graph that cross the boundary between those two sets of blocks; and
based on the determined edge(s), determining whether to move the instruction of the particular type to earlier in the program execution.

11. The method of claim 10, comprising determining, based on the determined edge(s) whether to:
not move the instruction of the particular type at all;
move the instruction of the particular type to the identified immediate dominator block; or
create a new dominator block at the boundary between the two sets of blocks to which the instruction of a particular type can be moved to.

12. An apparatus for providing a shader program for execution by a graphics processor that is operable to execute graphics shader programs, the apparatus comprising:
a processing circuit configured to generate a control flow graph for a shader program to be executed by a graphics processor;
a processing circuit configured to determine, based on the control flow graph:
whether to move an instruction of a particular type to earlier in the program execution; and
when it is determined to move the instruction of the particular type to earlier in the program execution, modify the shader program so as to move the instruction of the particular type earlier in the program execution; and
a processing circuit configured to provide the modified shader program for execution by a graphics processor.

13. The apparatus of claim 12, wherein the graphics shader program is a fragment shading program.

14. The apparatus of claim 12, further comprising:
a processing circuit configured to include an instruction of a particular type in a shader program to be executed by a graphics processor.

15. The apparatus of claim 12, wherein the instruction of a particular type is one of:
an instruction is a type or types of instruction that could result in the shader program execution being terminated;
an instruction that should not to be duplicated in the shader program execution;
a store instruction;
an instruction that has a side effect;
an instruction that triggers a fragment operation;
an instruction that triggers a fragment culling test operation;
an instruction that updates fragment culling information; and
an instruction that when executed will cause the fragment shader to determine whether a operation can be performed for a fragment being processed, and to, when it is determined that the operation can be performed for a fragment being processed, trigger the performance of the operation for the fragment being processed.

16. The apparatus of claim 12, wherein the processing circuit configured to determine, based on the control flow graph:
whether to move an instruction of a particular type to earlier in the program execution; and
when it is determined to move the instruction of the particular type to earlier in the program execution, modify the shader program so as to move the instruction of the particular type earlier in the program execution;
is configured to determine at least one of:
whether there are any instructions that would conflict with the instruction of the particular type;
whether there are any instructions that should be executed before the instruction of the particular type;
whether there are any instructions that the instruction of the particular type is dependent upon; and
whether there are any instructions that have side effects.

17. The apparatus of claim 12, wherein the processing circuit configured to determine, based on the control flow graph:
whether to move an instruction of a particular type to earlier in the program execution; and
when it is determined to move the instruction of the particular type to earlier in the program execution, modify the shader program so as to move the instruction of the particular type earlier in the program execution;
is configured to:
move an instruction of a particular type to a block in a control flow graph that dominates the block that the instruction of the particular type was present in.

18. The apparatus of claim 12, wherein the processing circuit configured to determine, based on the control flow graph:
whether to move an instruction of a particular type to earlier in the program execution; and
when it is determined to move the instruction of the particular type to earlier in the program execution, modify the shader program so as to move the instruction of the particular type earlier in the program execution;
is configured to:
create a new block in the control flow graph and move the instruction of the particular type to that new block in the control flow graph.

19. The apparatus of claim 12, wherein the processing circuit configured to determine, based on the control flow graph:
whether to move an instruction of a particular type to earlier in the program execution; and
when it is determined to move the instruction of the particular type to earlier in the program execution, modify the shader program so as to move the instruction of the particular type earlier in the program execution;
is configured to:
when moving an instruction of a particular type to earlier in the shader program execution, add instructions to the shader program to control the program flow through the modified shader program.

20. A non-transitory computer readable storage medium storing software code which when executing on at least one processor performs a method of providing a shader program for execution by a graphics processor that is operable to execute graphics shader programs, the method comprising:
generating a control flow graph for a shader program to be executed by a graphics processor;
based on the control flow graph:
determining whether to move an instruction of a particular type to earlier in the program execution; and
when it is determined to move the instruction of the particular type to earlier in the program execution, modifying the shader program so as to move the instruction of the particular type earlier in the program execution.
